(19) United States
(12) Patent Application Publication
(10) Pub. No.: US 2024/0421445 A1
(43) Pub. Date: Dec. 19, 2024

(54) BATTERY

(71) Applicant: SEMICONDUCTOR ENERGY LABORATORY CO., LTD., Atsugi-shi, Kanagawa-ken (JP)

(72) Inventors: Tatsuyoshi TAKAHASHI, Atsugi, Kanagawa (JP); Ryota TAJIMA, Isehara, Kanagawa (JP); Kazutaka KURIKI, Ebina, Kanagawa (JP); Mayumi MIKAMI, Atsugi, Kanagawa (JP)

(21) Appl. No.: 18/718,903

(22) PCT Filed: Dec. 2, 2022
(86) PCT No.: PCT/IB2022/061680

§ 371 Date: Jun. 12, 2024

(30) Foreign Application Priority Data
Dec. 17, 2021 (JP) 2021-204731

(51) Int. Cl. H01M 50/533; H01M 50/105; H01M 50/178

(52) U.S. Cl. CPC H01M 50/533; H01M 50/105; H01M 50/178

(57) ABSTRACT

To provide a battery in which electrode distortion is suppressed in connecting an electrode terminal and a current collector exposed portion. The battery includes an electrode, an exterior body surrounding the electrode, and a lead extending from the inside to the outside of the exterior body. The electrode includes a current collector and an active material layer. The electrode includes a first region where the active material layer is provided over the current collector, and a second region where the current collector is exposed. The second region of the electrode includes a third region where the current collector is folded. The lead is connected to the electrode in the third region.

### TECHNICAL FIELD

One embodiment of the present invention relates to a battery and a manufacturing method thereof. One embodiment of the present invention relates to a method for manufacturing an electrode and an apparatus for manufacturing an electrode. Another embodiment of the present invention relates to a portable information terminal, a vehicle, and the like each including a secondary battery.

Furthermore, one embodiment of the present invention relates to an object, a method, or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that an electronic device in this specification means all devices including power storage devices, and electro-optical devices including power storage devices, information terminal devices including power storage devices, and the like are all electronic devices.

Note that in this specification, a power storage device refers to all elements and devices each having a function of storing power. Examples of power storage devices include a power storage device (also referred to as a battery, a secondary battery, and the like) such as a lithium-ion secondary battery, a sodium-ion battery, and a nickel-hydrogen battery: a lithium-ion capacitor; and an electric double layer capacitor.

### BACKGROUND ART

In recent years, a variety of power storage devices such as lithium-ion secondary batteries, lithium-ion capacitors, and air batteries have been actively developed. In particular, demands for lithium-ion secondary batteries with high output and high energy density have rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like. The lithium-ion secondary batteries are essential as rechargeable energy supply sources for today's information society.

As structures of power storage devices, a variety of battery structures have been proposed in terms of weight energy density, volumetric energy density, safety, reliability, and the like.

### REFERENCE

### [Patent Document]

[Patent Document 1] PCT International Publication No. 2011/145205

### SUMMARY OF THE INVENTION

### Problems to be Solved by the Invention

An electrode of a power storage device sometimes employs a structure in which an active material layer (an active material coated portion) is provided over a current collector of metal foil. In this case, the current collector is often connected to an electrode terminal (also referred to as an electrode lead) in a region where the active material layer is not provided (hereinafter referred to as a current collector exposed portion, a non-coated portion, and the like).

In such a structure, the thickness of the active material coated portion is larger than the thickness of the current collector exposed portion. Therefore, as in a wound battery structure disclosed in Patent Document 1, when parts of the current collector exposed portion are gathered to be in contact with the electrode terminal at the time of connecting the current collector exposed portion and the electrode terminal, large distortion is caused in part of the electrode. This distortion might cause a problem of capacity decrease due to separation of an active material from the current collector, a problem of variations in reactions due to unequal electrode intervals, and the like.

In a stacked battery structure as well as the above-described example of the wound battery structure, a plurality of electrodes are often connected to the electrode terminal in the current collector exposed portion. At this time, large distortion is caused in part of the electrode in a manner similar to the above-described example.

Thus, an object of one embodiment of the present invention is to provide a battery in which electrode distortion is suppressed in connecting an electrode terminal and a current collector exposed portion. Another object is to provide a battery in which capacity decrease due to separation of an active material from a current collector is inhibited. Another object is to provide a battery in which variations in reactions due to unequal electrode intervals are suppressed.

Another object of one embodiment of the present invention is to provide a method for manufacturing a battery in which electrode distortion is suppressed in connecting an electrode terminal and a current collector exposed portion. Another object is to provide a method for manufacturing a battery in which capacity decrease due to separation of an active material from a current collector is inhibited. Another object is to provide a method for manufacturing a battery in which variations in reactions due to unequal electrode intervals are suppressed.

Note that the description of these objects does not preclude the existence of other objects. One embodiment of the present invention does not have to achieve all these objects. Other objects can be derived from the description of the specification, the drawings, and the claims.

### Means for Solving the Problems

One embodiment of the present invention is a battery including an electrode, an exterior body surrounding the electrode, and a lead extending from the inside to the outside of the exterior body. The electrode includes a current collector and an active material layer. The electrode includes a first region where the active material layer is provided over the current collector, and a second region where the current collector is exposed. The second region of the electrode includes a third region where the current collector is folded. The lead is connected to the electrode in the third region.

In the above-described battery, given that the thickness of the first region is 1, the thickness of the third region is preferably greater than or equal to 0.5 and less than or equal to 2.5.

Another embodiment of the present invention is a battery including an exterior body surrounding a negative electrode, a positive electrode, and a separator; and a negative lead and a positive lead that extend from the inside to the outside of the exterior body. The negative electrode includes a negative electrode current collector and a negative electrode active material layer. The positive electrode includes a positive electrode current collector and a positive electrode active material layer. The separator is positioned between the negative electrode active material layer and the positive electrode active material layer. The negative electrode includes a first region where the negative electrode active material layer is provided over the negative electrode current collector, and a second region where the negative electrode current collector is exposed. The second region of the negative electrode includes a third region where the negative electrode current collector is folded. The positive electrode includes a fourth region where the positive electrode active material layer is provided over the positive electrode current collector, and a fifth region where the positive electrode current collector is exposed. The fifth region of the positive electrode includes a sixth region where the positive electrode current collector is folded. Given that the total thickness of the thickness of the first region of the negative electrode, the thickness of the fourth region of the positive electrode, and the thickness of the separator is 1, the thickness of the third region of the negative electrode is greater than or equal to 0.5 and less than or equal to 1.2. Given that the total thickness of the thickness of the first region of the negative electrode, the thickness of the fourth region of the positive electrode, and the thickness of the separator is 1, the thickness of the sixth region of the positive electrode is greater than or equal to 0.5 and less than or equal to 1.2. The negative electrode lead is connected to the negative electrode in the third region. The positive electrode lead is connected to the positive electrode in the sixth region.

### Effect of the Invention

According to one embodiment of the present invention, a battery in which electrode distortion is suppressed in connecting an electrode terminal and a current collector exposed portion can be provided. Alternatively, a battery in which capacity decrease due to separation of an active material from a current collector is inhibited can be provided. Alternatively, a battery in which variations in reactions due to unequal electrode intervals are suppressed can be provided.

Alternatively, according to one embodiment of the present invention, a method for manufacturing a battery in which electrode distortion is suppressed in connecting an electrode terminal and a current collector exposed portion can be provided. Alternatively, a method for manufacturing a battery in which capacity decrease due to separation of an active material from a current collector is inhibited can be provided. Alternatively, a method for manufacturing a battery in which variations in reactions due to unequal electrode intervals are suppressed can be provided.

Note that the description of these effects does not preclude the existence of other effects. One embodiment of the present invention does not have to have all these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A to FIG. 1C are diagrams illustrating a structure example of a battery.

FIG. 2A to FIG. 2C are schematic cross-sectional views illustrating structure examples of an electrode.

FIG. 3A and FIG. 3B are schematic views illustrating structure examples of electrodes.

FIG. 4A to FIG. 4C are schematic cross-sectional views illustrating structure examples of stacks.

FIG. 5A and FIG. 5B are schematic cross-sectional views illustrating a structure example of a stack.

FIG. 6A and FIG. 6B are schematic cross-sectional views illustrating structure examples of stacks.

FIG. 7A to FIG. 7C are diagrams illustrating a structure example of a battery.

FIG. 8A and FIG. 8B are diagrams illustrating structure examples of batteries.

FIG. 9 is a diagram illustrating a structure example of a battery.

FIG. 10A and FIG. 10B are diagrams illustrating a structure example of a battery.

FIG. 11A and FIG. 11B are diagrams illustrating a structure example of a battery.

FIG. 12 is a diagram illustrating a method for processing a film.

FIG. 13A to FIG. 13E are diagrams each illustrating a method for processing a film.

FIG. 14A and FIG. 14B are diagrams each illustrating a method for processing a film.

FIG. 15A and FIG. 15B are diagrams illustrating an electronic device of one embodiment of the present invention.

FIG. 16A and FIG. 16B are diagrams illustrating an electronic device of one embodiment of the present invention.

FIG. 17A to FIG. 17D are diagrams illustrating electronic devices of embodiments of the present invention.

FIG. 18A to FIG. 18D are diagrams illustrating electronic devices of embodiments of the present invention.

FIG. 19A to FIG. 19C are diagrams illustrating an electronic device of one embodiment of the present invention.

FIG. 20A to FIG. 20C are diagrams illustrating an electronic device of one embodiment of the present invention.

FIG. 21A is a perspective view illustrating an example of a battery pack. FIG. 21B is a block diagram illustrating an example of a battery pack. FIG. 21C is a block diagram illustrating an example of a vehicle including a motor.

FIG. 22A to FIG. 22E are diagrams illustrating examples of transport vehicles.

FIG. 23A is a diagram illustrating an electric bicycle, FIG. 23B is a diagram illustrating a secondary battery of an electric bicycle, and FIG. 23C is a diagram illustrating an electric motorcycle.

FIG. 24A and FIG. 24B are diagrams illustrating examples of power storage devices.

FIG. 25A to FIG. 25D are diagrams illustrating examples of devices for space.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

In the drawings, the size, the layer thickness, or the region is exaggerated for clarity in some cases. Therefore, they are not limited to the illustrated scale.

The ordinal numbers such as “first” and “second” in this specification and the like are used for convenience and do not denote the order of steps or the stacking order of layers. Therefore, for example, the term “first” can be replaced with the term “second”, “third”, or the like as appropriate. In addition, the ordinal numbers in this specification and the like do not sometimes correspond to the ordinal numbers that are used to specify one embodiment of the present invention.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

The particle diameter of a particle can be measured by laser diffraction particle size distribution measurement, for example, and can be represented as D50. D50 is a particle diameter when the cumulative volume of a particle size distribution curve accounts for 50% in a measurement result of the particle size distribution, i.e., a median diameter. The measurement of the particle diameter of a particle is not limited to laser diffraction particle size distribution measurement: in the case where the particle diameter of a particle is less than or equal to the lower measurement limit of laser diffraction particle size distribution measurement, the cross-sectional diameter of a particle may be measured by analysis with a SEM (scanning electron microscope), a TEM (transmission electron microscope), or the like. As a method for measuring the particle diameter of a particle whose cross-sectional shape is not a circle, for example, the cross-sectional area of the particle is calculated by image processing or the like, whereby the particle diameter can be estimated assuming that the particle has a circular cross section with the equivalent area.

Electrodes (a positive electrode and a negative electrode) each include an active material layer and a current collector. An electrode in which one surface of a current collector is provided with an active material layer is referred to as a single-side-coated electrode, and an electrode in which both surfaces of a current collector are provided with active material layers is referred to as a double-side-coated electrode.

### Embodiment 1

In this embodiment, a battery of one embodiment of the present invention will be described.

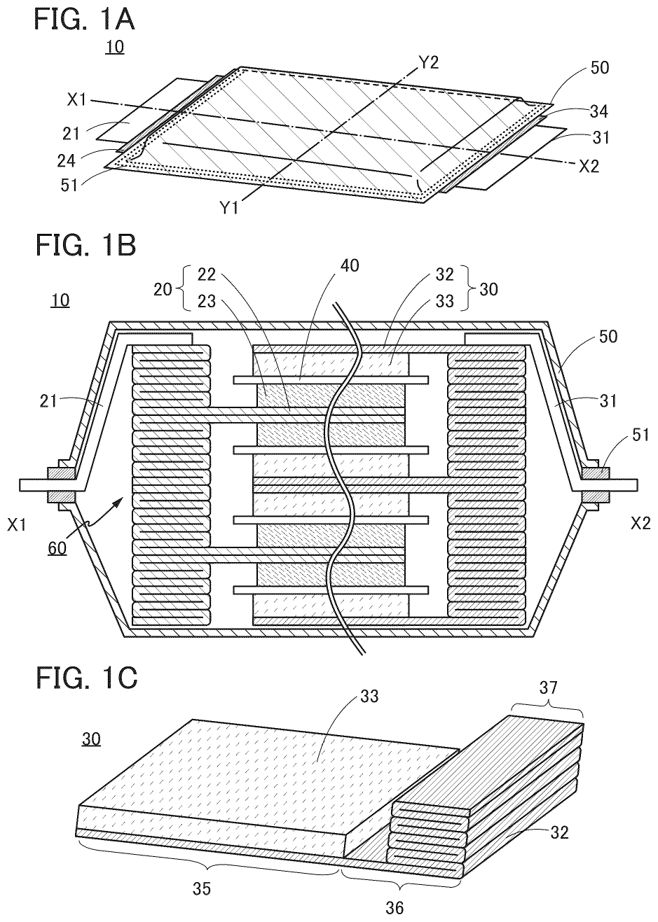

FIG. 1A and FIG. 1B are diagrams illustrating an example of a battery of one embodiment of the present invention. FIG. 1C is a diagram illustrating an example of an electrode included in the battery of one embodiment of the present invention.

FIG. 1A illustrates a battery 10. The battery 10 includes an exterior body 50, and a positive electrode lead 21 and a negative electrode lead 31 that extend from the inside to the outside of the exterior body 50. The exterior body 50 is sealed with a sealing portion 24, a sealing portion 34, and a sealing portion 51.

FIG. 1B is a schematic cross-sectional view taken along the dashed-dotted line X1-X2 in FIG. 1A. The battery 10 includes a positive electrode 20, a negative electrode 30, a separator 40, and the exterior body 50. The positive electrode 20, the negative electrode 30, and the separator 40 are surrounded by the exterior body 50. The positive electrode 20 and the positive electrode lead 21 are electrically connected to each other, and the positive electrode lead 21 extends from the inside to the outside of the exterior body 50. The negative electrode 30 and the negative electrode lead 31 are electrically connected to each other, and the negative electrode lead 31 extends from the inside to the outside of the exterior body 50.

The positive electrode 20 includes a positive electrode current collector 22 and a positive electrode active material layer 23, and the negative electrode 30 includes a negative electrode current collector 32 and a negative electrode active material layer 33. The separator 40 includes at least a region positioned between the positive electrode active material layer 23 and the negative electrode active material layer 33.

An example of an electrode included in the battery of one embodiment of the present invention will be described with reference to FIG. 1C. In the negative electrode 30 illustrated in FIG. 1C, the negative electrode 30 includes a first region 35 including the negative electrode current collector 32 and the negative electrode active material layer 33, a second region 36 where the negative electrode current collector 32 is exposed, and a third region 37 where the negative electrode current collector 32 is folded. The third region 37 is positioned in the second region 36. Note that the first region 35 can be referred to as an active material coated portion, the second region 36 can be referred to as a current collector exposed portion, and the third region 37 can be referred to as a current collector folded portion. In either case where the negative electrode 30 is a single-side-coated electrode or a double-side-coated electrode, a region where at least one surface of the current collector is provided with the active material layer is referred to as an active material coated portion.

The negative electrode 30 is described as an example in FIG. 1C: the positive electrode 20 also preferably employs a structure similar to that of the negative electrode 30 illustrated in FIG. 1C. Although not illustrated, the positive electrode 20 includes a fourth region including the positive electrode current collector 22 and the positive electrode active material layer 23, a fifth region where the positive electrode current collector is exposed, and a sixth region where the positive electrode current collector is folded. The sixth region is positioned in the fifth region. Note that the fourth region can be referred to as an active material coated portion, the fifth region can be referred to as a current collector exposed portion, and the sixth region can be referred to as a current collector folded portion.

As illustrated in FIG. 1B, the negative electrode lead 31 is connected to the negative electrode 30 in the third region 37 (the current collector folded portion). The positive electrode lead 21 is connected to the positive electrode 20 in the sixth region (the current collector folded portion). Such a stack in which the positive electrode 20, the negative electrode 30, and the separator 40 are stacked, the positive electrode 20 and the positive electrode lead 21 are connected to each other, and the negative electrode 30 and the negative electrode lead 31 are connected to each other is referred to as a stack 60.

As illustrated in FIG. 1A to FIG. 1C, the electrode (the positive electrode 20 and the negative electrode 30) included in the battery 10 preferably includes a current collector folded portion. 1. Moreover, the electrode (the positive electrode 20 and the negative electrode 30) included in the battery 10 is preferably connected to the electrode lead (the positive electrode lead 21 and the negative electrode lead 31) in the current collector folded portion.

In the case where the electrode does not include a current collector folded portion, a difference between the thickness of the electrode in the active material coated portion and the thickness of the portion where the electrode lead is connected (the current collector exposed portion) increases: thus, distortion is caused in the electrode when the electrode lead is made connected to the current collector exposed portion. This distortion might cause a problem of capacity decrease due to separation of the active material from the current collector, a problem of variations in reactions due to unequal electrode intervals, and the like.

On the other hand, in the case where the electrode includes a current collector folded portion and the electrode lead is connected to the electrode in the current collector folded portion, a difference between the thickness of the electrode in the active material coated portion and the thickness of the portion where the electrode lead is connected (the current collector folded portion) can be decreased. Accordingly, electrode distortion caused when the electrode lead is made connected can be reduced. For example, in the case where the total thickness of the active material coated portion and the separator and the total thickness of the current collector folded portion are made equal to each other, electrode distortion caused when the electrode lead is made connected can be eliminated. In other words, a battery with little capacity decrease and a battery with small variations in reactions can be obtained.

As a method for connecting the current collector folded portion and the electrode lead, the current collector folded portion and the electrode lead are preferably welded. As a method for welding, a welding method such as ultrasonic welding, resistance welding, or laser welding can be employed, for example. Alternatively, the current collector folded portion and the electrode lead may be sandwiched and fixed (held) by a fixing member.

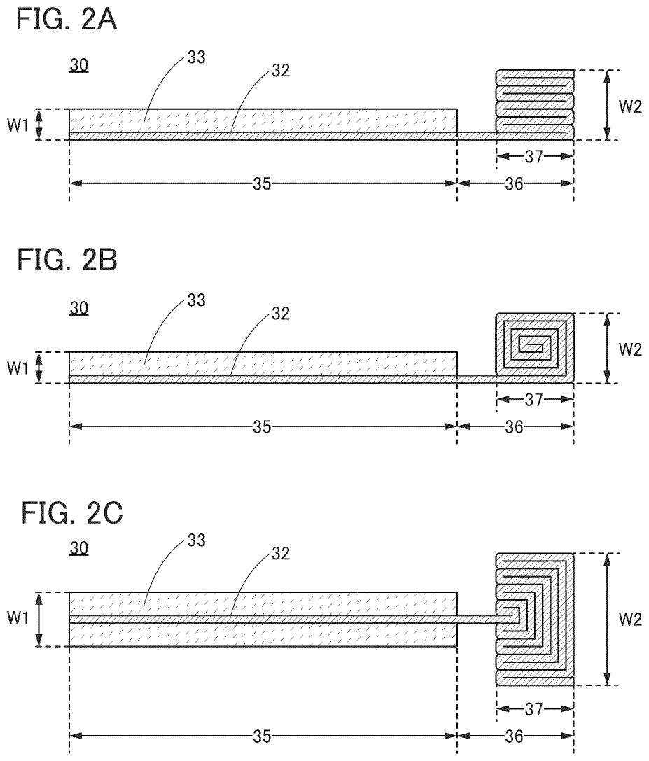

The current collector folded portion will be described with reference to a schematic cross-sectional view of the negative electrode 30 in FIG. 2A. As described above, the negative electrode 30 includes the first region 35 including the negative electrode current collector 32 and the negative electrode active material layer 33, the second region 36 where the negative electrode current collector 32 is exposed, and the third region 37 where the negative electrode current collector 32 is folded. The third region 37 is positioned in the second region 36.

In the negative electrode used in the battery of one embodiment of the present invention, a thickness W2 of the third region 37 (the current collector folded portion) is preferably larger than the thickness of the negative electrode current collector 32, and the thickness W2 of the third region 37 (the current collector folded portion) is further preferably larger than a thickness W1 of the first region (the active material coated portion).

For example, given that the thickness W1 of the first region (the active material coated portion) is 1, the thickness W2 of the third region 37 (the current collector folded portion) is preferably greater than or equal to 0.5 and less than or equal to 2.5, further preferably greater than or equal to 1.0 and less than or equal to 2.5.

Note that the negative electrode used in the battery of one embodiment of the present invention is not limited to the example illustrated in FIG. 2A. For example, instead of the third region 37 formed by folding part of the second region 36 of the negative electrode current collector 32 as illustrated in FIG. 2A, the third region 37 may be formed by winding part of the second region 36 of the negative electrode current collector 32 as illustrated in FIG. 2B. Note that the third region 37 illustrated in FIG. 2B may be referred to as a current collector wound portion.

The negative electrode used in the battery of one embodiment of the present invention can be applied to a double-side-coated electrode by employing a structure where the negative electrode current collector 32 is folded on both sides as illustrated in FIG. 2C, as well as to a single-side-coated electrode such as ones illustrated in FIG. 2A and FIG. 2B.

Also in the negative electrode 30 illustrated in FIG. 2B and FIG. 2C, the thickness W2 of the third region 37 (the current collector folded portion) is preferably larger than the thickness of the negative electrode current collector 32, and the thickness W2 of the third region 37 (the current collector folded portion) is further preferably larger than the thickness W1 of the first region (the active material coated portion). For example, given that the thickness W1 of the first region (the active material coated portion) is 1, the thickness W2 of the third region 37 (the current collector folded portion) is preferably greater than or equal to 0.5 and less than or equal to 2.5, further preferably greater than or equal to 1.0 and less than or equal to 2.5.

The negative electrode 30 is described as examples in FIG. 2A to FIG. 2C: the positive electrode 20 also preferably employs a structure similar to that of the negative electrode 30 illustrated in any of FIG. 2A to FIG. 2C. Although not illustrated, the thickness of the sixth region (the current collector folded portion) is preferably larger than the thickness of the positive electrode current collector 22, and the thickness of the sixth region (the current collector folded portion) is further preferably larger than the thickness of the fourth region (the active material coated portion). For example, given that the thickness of the fourth region (the active material coated portion) is 1, the thickness of the sixth region (the current collector folded portion) is preferably greater than or equal to 0.5 and less than or equal to 2.5, further preferably greater than or equal to 1.0 and less than or equal to 2.5.

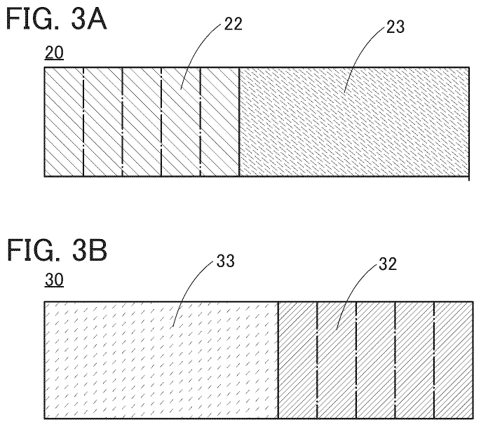

FIG. 3A and FIG. 3B are each a schematic plan view of the electrode before the current collector is folded.

The positive electrode 20 illustrated in FIG. 3A includes the positive electrode active material layer 23 and the positive electrode current collector 22. The positive electrode current collector 22 can be folded at positions of the dashed-dotted lines in the drawing, for example.

The negative electrode 30 illustrated in FIG. 3B includes the negative electrode active material layer 33 and the negative electrode current collector 32. The negative electrode current collector 32 can be folded at positions of the dashed-dotted lines in the drawing, for example.

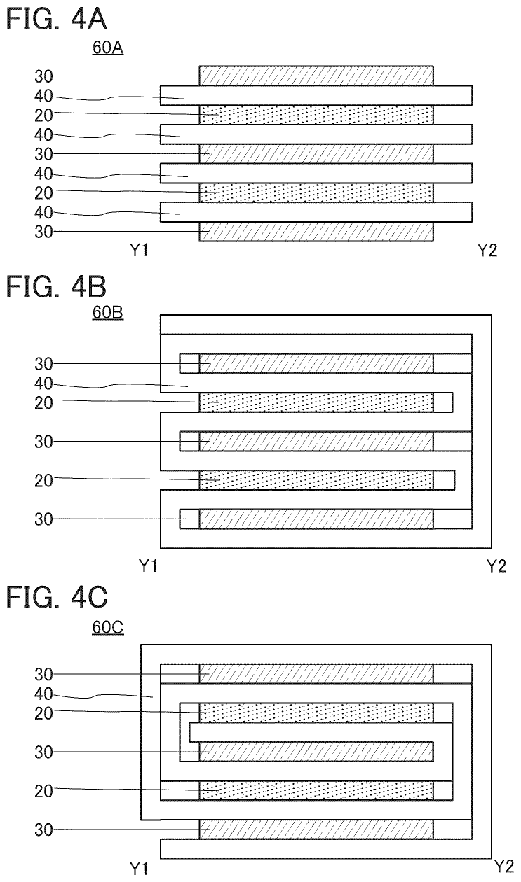

FIG. 4A to FIG. 4C are schematic cross-sectional views illustrating examples of the stack 60 in which the positive electrodes 20, the negative electrodes 30, and the separator(s) 40 are stacked. The schematic cross-sectional views illustrated in FIG. 4A to FIG. 4C are schematic views of the Y1-Y2 cross section of the battery 10 illustrated in FIG. 1A, and omit the exterior body 50. In the positive electrode 20 and the negative electrode 30, a current collector and an active material layer are omitted in order to avoid the complexity of the drawing.

As illustrated in FIG. 4A to FIG. 4C, the separator 40 includes a region positioned between the positive electrode 20 and the negative electrode 30. In other words, the positive electrode 20 and the negative electrode 30 include a region where they overlap with each other with the separator 40 therebetween. Note that the separator 40 may include a region positioned between the positive electrode 20 and the exterior body 50 and may include a region positioned between the negative electrode 30 and the exterior body 50.

A stack including a plurality of positive electrodes 20, a plurality of negative electrodes 30, and a plurality of separators 40, like a stack 60A illustrated in FIG. 4A, can be employed. A stack including a plurality of positive electrodes 20, a plurality of negative electrodes 30, and one separator 40, like a stack 60B and a stack 60C illustrated in FIG. 4B and FIG. 4C, can be employed.

As in the stack 60B illustrated in FIG. 4B, the separator 40 having a winding shape can be positioned between the plurality of positive electrodes 20 and the plurality of negative electrodes 30.

As in the stack 60C illustrated in FIG. 4C, the separator 40 having a wound shape can be positioned between the plurality of positive electrodes 20 and the plurality of negative electrodes 30.

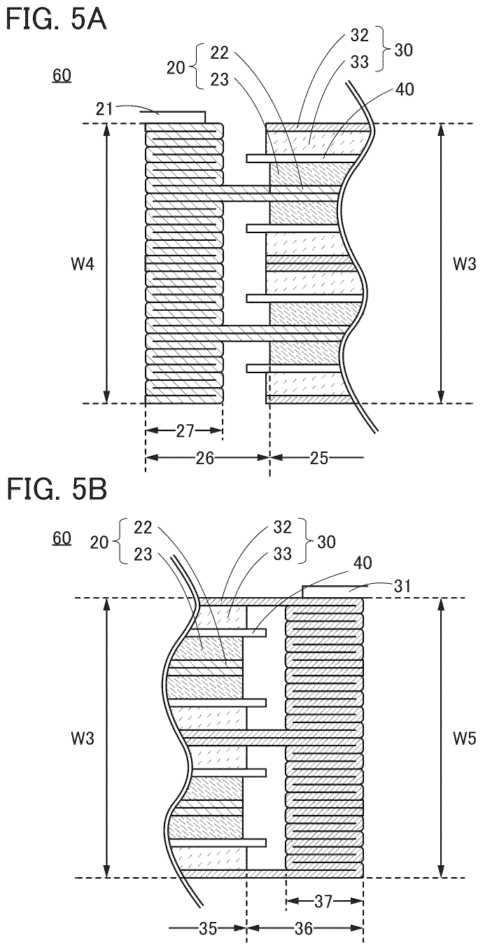

FIG. 5A and FIG. 5B are diagrams obtained by extracting part of the schematic cross-sectional view of the battery 10 illustrated in FIG. 1B. The thickness of the current collector folded portion in the stack 60 will be described with reference to FIG. 5A and FIG. 5B.

FIG. 5A is a schematic view illustrating a cross section around the connection portion of the positive electrode 20 and the positive electrode lead 21 in the stack 60. The positive electrode 20 includes a fourth region 25 including the positive electrode active material layer 23 over the positive electrode current collector 22 and a fifth region 26 where the positive electrode current collector 22 is exposed, and includes, in the fifth region 26, a sixth region 27 where the positive electrode current collector 22 is folded. The positive electrode 20 is stacked with the negative electrode 30 and the separator 40 in the fourth region 25 and is connected to the positive electrode lead 21 in the sixth region 27.

The sixth region 27 and the positive electrode lead 21 are preferably connected by welding the sixth region 27 and the positive electrode lead 21. As a method for welding, a welding method such as ultrasonic welding, resistance welding, or laser welding can be employed, for example. Alternatively, the sixth region 27 and the positive electrode lead 21 may be connected by sandwiching and fixing (holding) the sixth region 27 and the positive electrode lead 21 by a fixing member.

In the stack 60, the total thickness of a region where the fourth region 25 of the positive electrode 20, the negative electrode 30, and the separator 40 are stacked is denoted by a thickness W3; the total thickness of the sixth region 27 provided in the positive electrode 20 is denoted by a thickness W4. Here, given that the thickness W3 is 1, the thickness W4 is preferably greater than or equal to 0.5 and less than or equal to 1.2, further preferably greater than or equal to 0.7 and less than or equal to 1.1, still further preferably greater than or equal to 0.8 and less than or equal to 1.

FIG. 5B is a schematic view illustrating a cross section around the connection portion of the negative electrode 30 and the negative electrode lead 31 in the stack 60. The negative electrode 30 is stacked with the positive electrode 20 and the separator 40 in the first region 35 and is connected to the negative electrode lead 31 in the third region 37.

The third region 37 and the negative electrode lead 31 are preferably connected by welding the third region 37 and the negative electrode lead 31. As a method for welding, a welding method such as ultrasonic welding, resistance welding, or laser welding can be employed, for example. Alternatively, the third region 37 and the negative electrode lead 31 may be connected by sandwiching and fixing (holding) the third region 37 and the negative electrode lead 31 by a fixing member.

In the stack 60, the total thickness of a region where the first region 35 of the negative electrode 30, the positive electrode 20, and the separator 40 are stacked is denoted by the thickness W3: the total thickness of the third region 37 provided in the negative electrode 30 is denoted by a thickness W5. Here, given that the thickness W3 is 1, the thickness W5 is preferably greater than or equal to 0.5 and less than or equal to 1.2, further preferably greater than or equal to 0.7 and less than or equal to 1.1, still further preferably greater than or equal to 0.8 and less than or equal to 1.

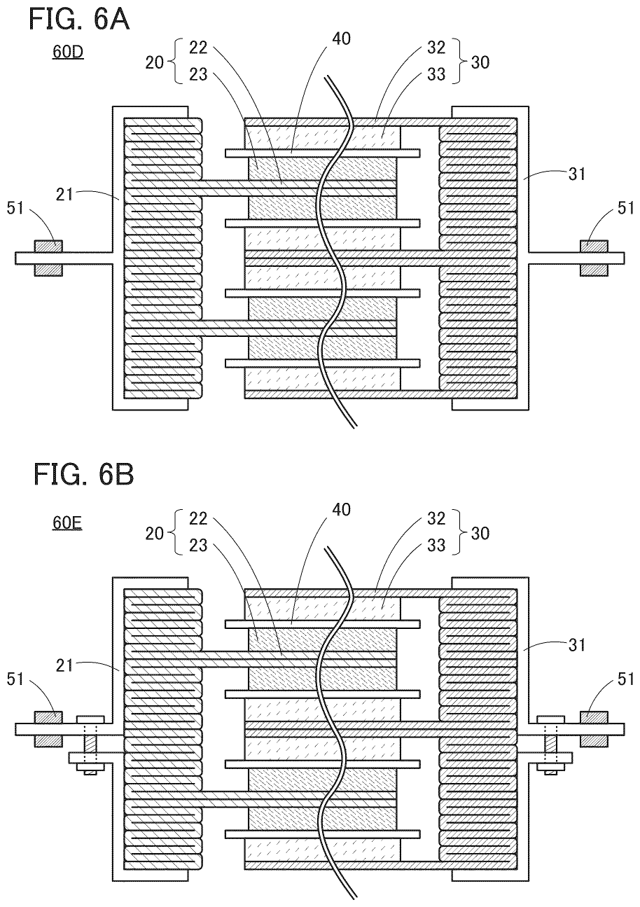

FIG. 6A and FIG. 6B illustrate examples of the stack 60 in which the sixth region 27 and the positive electrode lead 21 are connected by sandwiching and fixing (holding) the sixth region 27 by the positive electrode lead 21, and the third region 37 and the negative electrode lead 31 are connected by sandwiching and fixing (holding) the third region 37 by the negative electrode lead 31.

In a stack 60D illustrated in FIG. 6A and a stack 60E illustrated in FIG. 6B, the sixth region 27 included in the positive electrode 20 is sandwiched by the positive electrode lead 21. The third region 37 included in the negative electrode 30 is sandwiched by the negative electrode lead 31. The positive electrode lead 21 and the negative electrode lead 31 may each be one component as illustrated in FIG. 6A, or may have a structure where two or more components are fixed by a screw or the like as illustrated in FIG. 6B.

As illustrated in FIG. 6A and FIG. 6B, the positive electrode lead 21 preferably includes a region in contact with two surfaces, instead of only one surface, of the sixth region 27. The negative electrode lead 31 preferably includes a region in contact with two surfaces, instead of only one surface, of the third region 37. With such a structure, the contact area between the positive electrode 20 and the positive electrode lead 21 can be increased: thus, the contact resistance can be reduced. Similarly, the contact area between the negative electrode 30 and the negative electrode lead 31 can be increased: hence, the contact resistance can be reduced.

When the stack includes a plurality of positive electrodes and a plurality of negative electrodes as illustrated in FIG. 6A and FIG. 6B, the positive electrode lead 21 is preferably in contact with the plurality of positive electrodes 20. Moreover, the negative electrode lead 31 is preferably in contact with the plurality of negative electrodes 30. With such a structure, the contact area between the positive electrodes 20 and the positive electrode lead 21 can be increased; thus, the contact resistance can be reduced. Similarly, the contact area between the negative electrodes 30 and the negative electrode lead 31 can be increased: hence, the contact resistance can be reduced.

The total thickness of the active material coated region (the first region 35 and the fourth region 25) and the separator 40 and the total thickness of the current collector folded portion (the third region 37 and the sixth region 27) in the structures shown above are set in the above-described numerical range, thereby reducing distortion caused in the stack 60 when the electrode lead (the positive electrode lead 21 and the negative electrode lead 31) is made connected. In other words, a battery with little capacity decrease and a battery with small variations in reactions can be obtained.

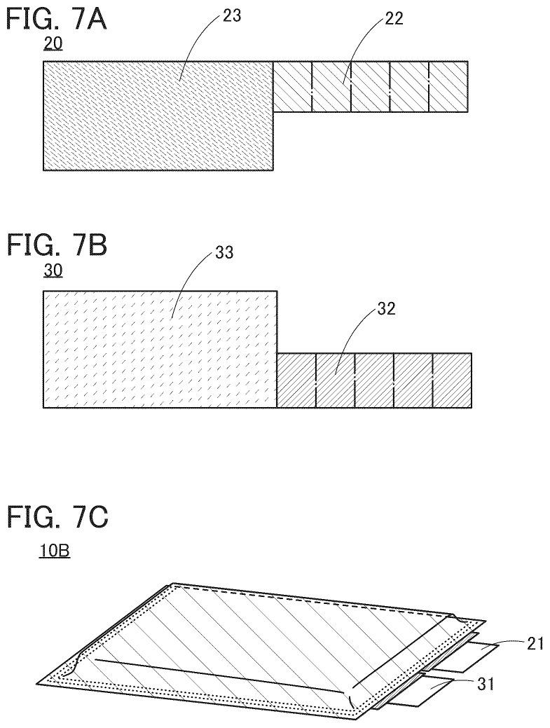

Note that FIG. 1 to FIG. 5 show examples in which the positive electrode lead 21 and the negative electrode lead 31 included in the battery 10 are respectively provided at one end and the other end on the opposite side of the battery 10: the arrangement of the positive electrode lead 21 and the negative electrode lead 31 is not limited to these examples. For example, a positive electrode shape of the positive electrode 20 illustrated in FIG. 7A can be employed, and a negative electrode shape of the negative electrode 30 illustrated in FIG. 7B can be employed. At this time, both the positive electrode lead 21 and the negative electrode lead 31 can be provided at one end of the battery as in a battery 10B illustrated in FIG. 7C.

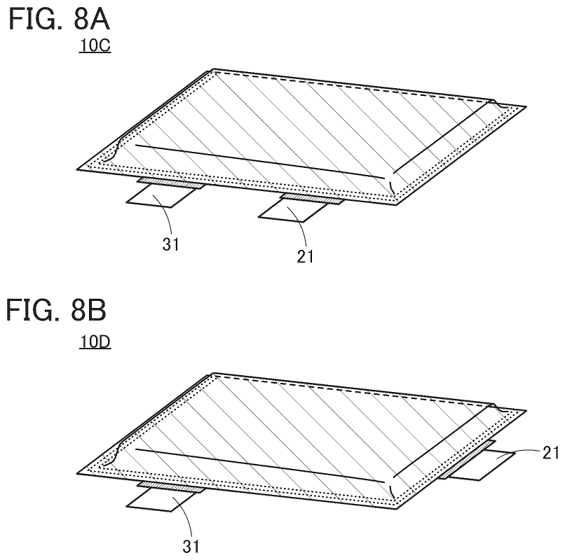

Both the positive electrode lead 21 and the negative electrode lead 31 may be provided on the short side(s) of the battery as illustrated in FIG. 1A and FIG. 7C, or both the positive electrode lead 21 and the negative electrode lead 31 may be provided on the long side of a battery as in a battery 10C illustrated in FIG. 8A. The positive electrode lead 21 may be provided on the short side of a battery and the negative electrode lead 31 may be provided on the long side of the battery as in a battery 10D illustrated in FIG. 8B. Alternatively, the positive electrode lead 21 may be provided on the long side of a battery and the negative electrode lead 31 may be provided on the short side of the battery.

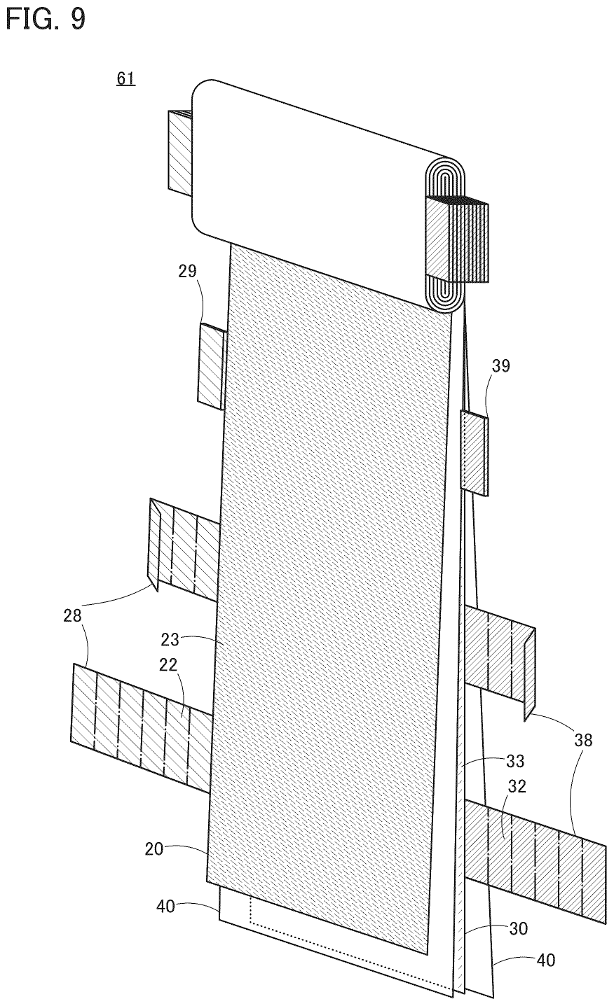

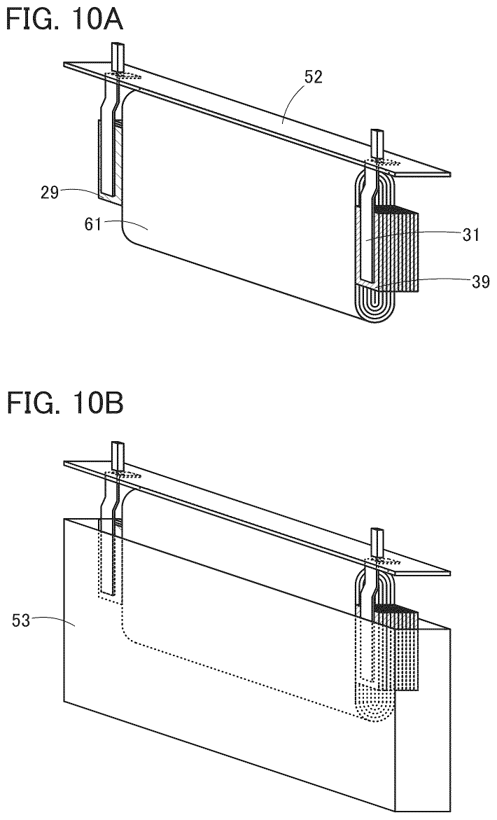

Note that the stacked battery structure is described as an example in FIG. 1 and the like; the battery of one embodiment of the present invention is not limited to the stacked battery structure. For example, a battery with a wound battery structure illustrated in FIG. 9 and FIG. 10 is also the battery of one embodiment of the present invention.

The schematic view illustrated in FIG. 9 is a diagram showing a method for forming a wound body 61 by stacking the positive electrode 20, the negative electrode 30, and a plurality of separators 40 and winding them into a flattened shape.

In FIG. 9, the positive electrode current collector 22 included in the positive electrode 20 includes a plurality of regions in contact with the positive electrode active material layer 23 and a plurality of projecting portions 28 where the positive electrode current collector exposed portion is projected, and positive electrode current collector folded portions 29 are provided in the projecting portions 28.

The negative electrode current collector 32 included in the negative electrode 30 includes a plurality of regions in contact with the negative electrode active material layer 33 and a plurality of projecting portions 38 where the negative electrode current collector exposed portion is projected, and negative electrode current collector folded portions 39 are provided in the projecting portions 38.

The plurality of positive electrode current collector folded portions 29 and the plurality of negative electrode current collector folded portions 39 have an overlap region in the wound body 61. As illustrated in FIG. 10A, the positive electrode current collector folded portion 29 is connected to the positive electrode lead 21, and the negative electrode current collector folded portion 39 is connected to the negative electrode lead 31. An exterior body 52 includes the positive electrode lead 21 and the negative electrode lead 31.

To connect the current collector folded portion (the positive electrode current collector folded portion 29 and the negative electrode current collector folded portion 39) and the electrode lead (the positive electrode lead 21 and the negative electrode lead 31), the current collector folded portion and the electrode lead are preferably welded. As a method for welding, a welding method such as ultrasonic welding, resistance welding, or laser welding can be employed, for example. Alternatively, the current collector folded portion and the electrode lead may be sandwiched and fixed (held) by a fixing member.

The total thickness of the positive electrode current collector folded portions 29 and the total thickness of the negative electrode current collector folded portions 39 in the wound body 61 are preferably in a range similar to the range of the thickness W4 and the thickness W5 shown in the description of FIG. 5. For example, given that the thickness of a region where the positive electrode active material coated portion, the negative electrode active material coated portion, and the separator 40 are stacked in the wound body 61 is 1, the total thickness of the positive electrode current collector folded portions 29 is preferably greater than or equal to 0.5 and less than or equal to 1.2, further preferably greater than or equal to 0.7 and less than or equal to 1.1, still further preferably greater than or equal to 0.8 and less than or equal to 1. Moreover, given that the thickness of the region where the positive electrode active material coated portion, the negative electrode active material coated portion, and the separator 40 are stacked in the wound body 61 is 1, the total thickness of the negative electrode current collector folded portions 39 is preferably greater than or equal to 0.5 and less than or equal to 1.2, further preferably greater than or equal to 0.7 and less than or equal to 1.1, still further preferably greater than or equal to 0.8 and less than or equal to 1.

The wound body 61 connected to the positive electrode lead 21 and the negative electrode lead 31, which are included in the exterior body 52, is positioned inside an exterior body 53, and the exterior body 52 and the exterior body 53 are connected to each other. In such a manner, the wound body 61 is surrounded by the exterior body 52 and the exterior body 53, and the positive electrode lead 21 and the negative electrode lead 31 extend from the inside to the outside of the exterior body 52 and the exterior body 53.

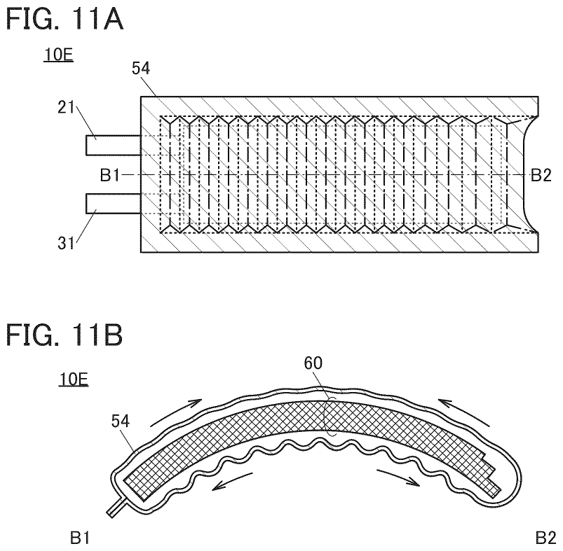

The battery of one embodiment of the present invention can have flexibility. For example, a battery 10E including an exterior body 54 having depressions and projections as illustrated in FIG. 11A has flexibility.

FIG. 11B is a schematic view showing a cross section along B1-B2 in FIG. 11A and illustrates a state where the battery 10E is being curved. The battery 10E can include the stack 60 illustrated in FIG. 1 and the like. The details of the exterior body having depressions and projections and the like will be described later.

Next, the positive electrode 20, the negative electrode 30, an electrolyte, the separator 40, and a film that can be used as the exterior body will be described. Although an electrolyte is not described in the above description of the battery 10 and the like and FIG. 1 to FIG. 11, the battery 10 and the like include an electrolyte. The following are examples of other applicable expressions: a space surrounded by the exterior body includes an electrolyte, the stack 60 includes an electrolyte, the wound body 61 includes an electrolyte, the positive electrode 20 includes an electrolyte, the negative electrode 30 includes an electrolyte, and the separator 40 includes an electrolyte.

### [Negative Electrode]

The negative electrode includes a negative electrode active material layer and a negative electrode current collector. The negative electrode active material layer includes a negative electrode active material, and may further include a conductive material and a binder.

Metal foil can be used as the current collector, for example. The negative electrode can be formed by applying slurry onto the metal foil and drying the slurry. Note that pressing may be performed after drying. The negative electrode is a component obtained by forming an active material layer over the current collector.

Slurry refers to a material solution that is used to form an active material layer over the current collector and includes an active material, a binder, and a solvent, preferably also a conductive material mixed therewith. Slurry may also be referred to as slurry for an electrode or active material slurry: in some cases, slurry for forming a negative electrode active material layer is referred to as slurry for a negative electrode.

### <Negative Electrode Active Material>

As the negative electrode active material, for example, a carbon-based material or an alloy-based material can be used.

As the carbon material, for example, graphite (natural graphite or artificial graphite), graphitizing carbon (soft carbon), non-graphitizing carbon (hard carbon), carbon fiber (carbon nanotube), graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Lit) when lithium ions are inserted into graphite (while a lithium-graphite intercalation compound is formed). For this reason, a lithium-ion battery using graphite can show a high operating voltage. In addition, graphite is preferred because of its advantages such as a relatively high capacity per unit volume, relatively small volume expansion, low cost, and a higher level of safety than that of a lithium metal.

Non-graphitizing carbon can be obtained by baking a synthetic resin such as a phenol resin or an organic substance of plant origin, for example. In non-graphitizing carbon contained in the negative electrode active material of the lithium-ion battery of one embodiment of the present invention, the interplanar spacing of a (002) plane, which is measured by X-ray diffraction (XRD), is preferably greater than or equal to 0.34 nm and less than or equal to 0.50 nm, further preferably greater than or equal to 0.35 nm and less than or equal to 0.42 nm.

As the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound containing the element, for example, are referred to as alloy-based materials in some cases.

In this specification and the like, SiO refers, for example, to silicon monoxide. Note that SiO can alternatively be expressed as SiOₓ. Here, it is preferable that x be 1 or have an approximate value of 1. For example, x is preferably greater than or equal to 0.2 and less than or equal to 1.5, or preferably greater than or equal to 0.3 and less than or equal to 1.2.

As the negative electrode active material, an oxide such as titanium dioxide (TiO₂), lithium titanium oxide (Li₄TisO₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}CO_{0.4}N₃ is preferable because of its high discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that even in the case of using a material containing lithium ions as a positive electrode active material, the composite nitride of lithium and a transition metal can be used as the negative electrode active material by extracting the lithium ions contained in the positive electrode active material in advance.

A material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

Note that one kind of negative electrode active material among the negative electrode active materials shown above can be used: alternatively, a plurality of kinds can be used in combination. For example, a combination of a carbon material and silicon or a combination of a carbon material and silicon monoxide can be used.

As another mode of the negative electrode, a negative electrode that does not contain a negative electrode active material at the completion of the fabrication of the battery may be used. As the negative electrode that does not contain a negative electrode active material, for example, a negative electrode can be used in which only a negative electrode current collector is included at the completion of the fabrication of the battery and in which lithium ions extracted from the positive electrode active material due to charging of the battery are deposited as a lithium metal over the negative electrode current collector and form the negative electrode active material layer. A battery including such a negative electrode is referred to as a negative electrode-free (anode-free) battery, a negative electrodeless (anodeless) battery, or the like in some cases.

In the case of using the negative electrode that does not contain a negative electrode active material, a film for making lithium deposition uniform may be provided over the negative electrode current collector. For the film for making lithium deposition uniform, for example, a solid electrolyte having lithium ion conductivity can be used. As the solid electrolyte, a sulfide-based solid electrolyte, an oxide-based solid electrolyte, a polymer-based solid electrolyte, or the like can be used. Among them, a film of the polymer-based solid electrolyte can be uniformly formed over the negative electrode current collector relatively easily, and thus is suitable as the film for making lithium deposition uniform. Moreover, as the film for making lithium deposition uniform, for example, a metal film that forms an alloy with lithium can be used. As the metal film that forms an alloy with lithium, for example, a magnesium metal film can be used. It is suitable for the film for making lithium deposition uniform because lithium and magnesium form a solid solution in a wide range of compositions.

In the case of using the negative electrode that does not contain a negative electrode active material, a negative electrode current collector having unevenness can be used. In the case of using the negative electrode current collector having unevenness, a depression of the negative electrode current collector becomes a cavity in which lithium contained in the negative electrode current collector is easily deposited, so that the lithium can be inhibited from having a dendrite-like shape when being deposited.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

A plurality of the above-described materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is further desirable that the passivation film can conduct lithium ions while inhibiting electrical conduction.

### <Conductive Material>

A conductive material is also referred to as a conductivity-imparting agent or a conductive additive, and a carbon material is used. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

Active material layers such as the positive electrode active material layer and the negative electrode active material layer preferably contain a conductive material.

For example, one kind or two or more kinds of carbon black such as acetylene black and furnace black, graphite such as artificial graphite and natural graphite, carbon fiber such as carbon nanofiber and carbon nanotube, and a graphene compound can be used as the conductive material.

As the carbon fiber, carbon fiber such as mesophase pitch-based carbon fiber or isotropic pitch-based carbon fiber can be used, for example. As the carbon fiber, carbon nanofiber, carbon nanotube, or the like can also be used. Carbon nanotube can be formed by, for example, a vapor deposition method.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like carbon nanofiber.

The active material layer may contain, as a conductive material, metal powder or metal fiber of copper, nickel, aluminum, silver, gold, or the like, a conductive ceramic material, or the like.

The content of the conductive material to the total volume of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, the graphene compound is capable of making low-resistance surface contact: accordingly, the electrical conduction between the particulate active material and the graphene compound can be improved with a smaller amount of the graphene compound than that of a normal conductive material. This can increase the proportion of the active material in the active material layer. Accordingly, the discharge capacity of the battery can be increased.

A particulate carbon-containing compound such as carbon black or graphite and a fibrous carbon-containing compound such as carbon nanotube easily enter a microscopic space. A microscopic space means, for example, a region or the like between a plurality of active materials. When a carbon-containing compound that easily enters a microscopic space and a sheet-like carbon-containing compound, such as graphene, that can impart conductivity to a plurality of particles are used in combination, the density of the electrode is increased and an excellent conductive path can be formed. The battery obtained by the manufacturing method of one embodiment of the present invention can have high capacity density and stability, and is effective as an in-vehicle battery.

### <Current Collector>

As the current collector, a highly conductive material that does not alloy with a carrier ion such as lithium, for example, a metal such as stainless steel, gold, platinum, zinc, iron, copper, aluminum, or titanium, or an alloy thereof can be used. The current collector can have a sheet-like shape, a net-like shape, a punching-metal shape, an expanded-metal shape, or the like as appropriate.

A resin current collector can be used as the current collector. As the resin current collector, for example, a resin current collector including a resin such as polyolefin (polypropylene, polyethylene, or the like), nylon (polyamide), polyimide, vinylon, polyester, acrylic, or polyurethane, and a particulate or fibrous conductive material (also referred to as a conductive filler) can be used.

As the conductive material contained in the resin current collector, a conductive carbon material and one or more of metal materials such as aluminum, titanium, stainless steel, gold, platinum, zinc, iron, and copper can be used. As the conductive carbon material, for example, one kind or two or more kinds of carbon black such as acetylene black and furnace black, graphite such as artificial graphite and natural graphite, carbon fiber such as carbon nanofiber and carbon nanotube, graphene, and a graphene compound can be used. Note that in the case where the resin current collector is used as a positive electrode current collector, an antioxidant such as a hindered phenol-based material is further preferably used.

As the carbon fiber, carbon fiber such as mesophase pitch-based carbon fiber or isotropic pitch-based carbon fiber can be used, for example. As the carbon fiber, carbon nanofiber, carbon nanotube, or the like can also be used. Carbon nanotube can be formed by, for example, a vapor deposition method.

Note that the average particle diameter of the conductive material contained in the resin current collector can be greater than or equal to 10 nm and less than or equal to 10 μm, and is preferably greater than or equal to 30 nm and less than or equal to 5 μm.

The current collector preferably has a thickness greater than or equal to 5 μm and less than or equal to 30 μm.

Note that a material that does not alloy with carrier ions of lithium or the like is preferably used for the negative electrode current collector.

### [Positive Electrode]

The positive electrode includes a positive electrode active material layer and a positive electrode current collector. The positive electrode active material layer includes a positive electrode active material and may further include at least one of a conductive material and a binder. Note that for the positive electrode current collector, the conductive material, and the binder, the materials described in [Negative electrode] can be used.

Metal foil can be used as the current collector, for example. The positive electrode can be formed by applying slurry onto the metal foil and drying the slurry. Note that pressing may be performed after drying. The positive electrode is a component obtained by forming an active material layer over the current collector.

Slurry refers to a material solution that is used to form an active material layer over the current collector and includes an active material, a binder, and a solvent, preferably also a conductive material mixed therewith. Slurry may also be referred to as slurry for an electrode or active material slurry: in some cases, slurry for forming a positive electrode active material layer is referred to as slurry for a positive electrode.

### <Positive Electrode Active Material>

As the positive electrode active material, one or more of composite oxide having a layered rock-salt structure, composite oxide having an olivine structure, and composite oxide having a spinel structure can be used.

As the composite oxide having a layered rock-salt structure, one or more of lithium cobalt oxide, lithium nickel-cobalt-manganese oxide, lithium nickel-cobalt-aluminum oxide, and lithium nickel-manganese-aluminum oxide can be used. Note that the composition formula can be represented by LiM1O₂ (M1 is one or more selected from nickel, cobalt, manganese, and aluminum), and a coefficient of the composition formula is not limited to an integer.

As the lithium cobalt oxide, for example, lithium cobalt oxide to which magnesium and fluorine are added can be used. It is preferable to use lithium cobalt oxide to which magnesium, fluorine, aluminum, and nickel are added.

As the lithium nickel-cobalt-manganese oxide, for example, it is possible to use lithium nickel-cobalt-manganese oxide with a ratio such as nickel:cobalt:manganese=1:1:1, nickel:cobalt:manganese=6:2:2, nickel:cobalt:manganese=8:1:1, or nickel:cobalt:manganese=9:0.5:0.5. As the above-described lithium nickel-cobalt-manganese oxide, for example, lithium nickel-cobalt-manganese oxide to which one or more of aluminum, calcium, barium, strontium, and gallium are added is preferably used.

As the composite oxide having an olivine structure, one or more of lithium iron phosphate, lithium manganese phosphate, lithium cobalt phosphate, and lithium iron manganese phosphate can be used. Note that the composition formula can be represented by LiM2PO₄ (M2 is one or more selected from iron, manganese, and cobalt), and a coefficient of the composition formula is not limited to an integer.

Furthermore, composite oxide having a spinel structure, such as LiMn₂O₄, can be used.

### [Electrolyte]

An example of an electrolyte is described below. As one mode of the electrolyte, a liquid electrolyte (also referred to as an electrolyte solution) containing a solvent and an electrolyte dissolved in the solvent can be used. The electrolyte is not limited to a liquid electrolyte (electrolyte solution) that is liquid at room temperature, and a solid electrolyte can be used as well. Alternatively, an electrolyte including both a liquid electrolyte that is liquid at room temperature and a solid electrolyte that is a solid at room temperature (such an electrolyte is referred to as a semi-solid electrolyte) can also be used. Note that when the solid electrolyte or the semi-solid electrolyte is used for a bendable battery, employing a structure where part of a stack in the battery includes the electrolyte can maintain the flexibility of the battery.

In the case of using a liquid electrolyte for a battery, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more thereof can be used in an appropriate combination at an appropriate ratio, for example.

The use of one or more ionic liquids (room temperature molten salts) that are less likely to burn and volatize as the solvent of the electrolyte can prevent a battery from exploding or catching fire even when the battery internally shorts out or the internal temperature increases owing to overcharge or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

The battery of one embodiment of the present invention includes, as a carrier ion, an alkali metal ion such as a lithium ion, a sodium ion, or a potassium ion or an alkaline earth metal ion such as a calcium ion, a strontium ion, a barium ion, a beryllium ion, or a magnesium ion, for example.

In the case where lithium ions are used as carrier ions, the electrolyte contains lithium salt, for example. As the lithium salt, LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LIC (CF₃SO₂)₃, LiC(C₂FsSO₂)₃, LiN(CF₃SO₂)₂, LiN(C₄F₉SO₂)(CF₃SO₂), LIN (C₂FsSO₂)₂, or the like can be used, for example.

An organic solvent described as an example in this embodiment can be an organic solvent containing ethylene carbonate (EC), ethyl methyl carbonate (EMC), and dimethyl carbonate (DMC): given that the total volume of the ethylene carbonate, the ethyl methyl carbonate, and the dimethyl carbonate is 100 vol %, the volume ratio between the ethylene carbonate, the ethyl methyl carbonate, and the dimethyl carbonate is x:y:100−x−y (where 5≤x≤35 and 0<y<65). More specifically, an organic solvent containing EC, EMC, and DMC at EC:EMC:DMC=30:35:35 (volume ratio) can be used.

The electrolyte solution is preferably highly purified and contains a small amount of dust particles and elements other than the constituent elements of the electrolyte solution (hereinafter also simply referred to as “impurities”). Specifically, the weight ratio of impurities to the electrolyte solution is preferably less than or equal to 1%, further preferably less than or equal to 0.1%, still further preferably less than or equal to 0.01%.

In order to form a coating film (Solid Electrolyte Interphase) at the interface between an electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis(oxalate) borate (LiBOB), or a dinitrile compound such as succinonitrile or adiponitrile may be added to the electrolyte solution. The concentration of such an additive agent in the solvent is, for example, higher than or equal to 0.1 wt % and lower than or equal to 5 wt %.

When the electrolyte contains a high-molecular material capable of gelation, safety against liquid leakage and the like is improved. Typical examples of a gelling high-molecular material include a silicone gel, an acrylic gel, an acrylonitrile gel, a polyethylene oxide-based gel, a polypropylene oxide-based gel, and a gel of a fluorine-based polymer.

As the high-molecular material, for example, a polymer having a polyalkylene oxide structure, such as polyethylene oxide (PEO); PVDF; polyacrylonitrile; a copolymer containing any of them; and the like can be used. For example, PVDF-HFP, which is a copolymer of PVDF and hexafluoropropylene (HFP), can be used. The formed polymer may be porous.

### [Separator]

When the electrolyte includes an electrolyte solution, a separator is positioned between the positive electrode and the negative electrode. The separator can be formed using, for example, fiber containing cellulose, such as paper, nonwoven fabric, glass fiber, ceramics, or synthetic fiber containing nylon (polyamide), polyimide, vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramic-based material, a fluorine-based material, a polyamide-based material, a polyimide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-aramid and para-aramid).

When the separator is coated with the ceramic-based material, the oxidation resistance is improved: hence, degradation of the separator during high-voltage charging and discharging can be inhibited and thus the reliability of the battery can be improved. When the separator is coated with the fluorine-based material, the separator is easily brought into close contact with an electrode, resulting in high output performance. When the separator is coated with the polyamide-based material, in particular, aramid, the heat resistance is improved: thus, the safety of the battery can be improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the battery can be increased because the safety of the battery can be maintained even when the total thickness of the separator is small.

### [Exterior Body]

For an exterior body included in the battery, a metal material such as aluminum, stainless steel, or titanium or a resin material can be used, for example. A film-like exterior body can also be used. As the film, for example, it is possible to use a film having a three-layer structure in which a highly flexible metal thin film or metal foil of aluminum, stainless steel, titanium, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. Such a film with a multilayer structure can be referred to as a laminated film. At this time, the laminated film is sometimes referred to as an aluminum laminated film, a stainless steel laminated film, a titanium laminated film, a copper laminated film, a nickel laminated film, or the like using the material name of the metal layer included in the laminated film.

The material or thickness of the metal layer included in the laminated film sometimes affects the flexibility of a battery. As an exterior body used for a highly flexible (bendable) battery, for example, an aluminum laminated film including a polypropylene layer, an aluminum layer, and nylon is preferably used. Here, the thickness of the aluminum layer is preferably smaller than or equal to 50 μm, further preferably smaller than or equal to 40 μm, still further preferably smaller than or equal to 30 μm, yet further preferably smaller than or equal to 20 μm. Note that in the case where the thickness of the aluminum layer is smaller than 10 μm, a gas barrier property might be lowered by pinholes of the aluminum layer: thus, the thickness of the aluminum layer is desirably larger than or equal to 10 μm.

A graphene sheet may be substituted for the above metal layer of the laminate film. As the graphene sheet, a multilayer graphene sheet with a thickness larger than or equal to 100 nm and smaller than or equal to 30 μm, preferably larger than or equal to 200 nm and smaller than or equal to 20 μm can be used. The graphene sheet is flexible and has a gas barrier property with the interlayer distance of graphene of 0.34 nm, and thus is suitable as a film used for the exterior body of the battery.

### [Method for Processing Film Having Depressed Portions and Projected Portions]

Next, a method for processing a film that can be used for the exterior body 54 illustrated in FIG. 11 will be described. As the film, the above-described laminated film can be used.

As the laminated film, a stack in which a heat-seal layer is provided on one or both surfaces of a metal film can be used, for example. As an adhesive layer, a heat-sealing resin film containing polypropylene, polyethylene, or the like can be used. This embodiment employs an aluminum laminated film in which a nylon resin is provided on the top surface of aluminum foil and a stack of an acid-resistant polypropylene film and a polypropylene film is provided on the back surface of the aluminum foil.

Then, the film is embossed. As a result, the film having depressions and projections can be formed. The film includes a plurality of depressed and projected portions, thereby having a wave pattern that can be visually recognized.

Embossing, which is a type of pressing, will be described below.

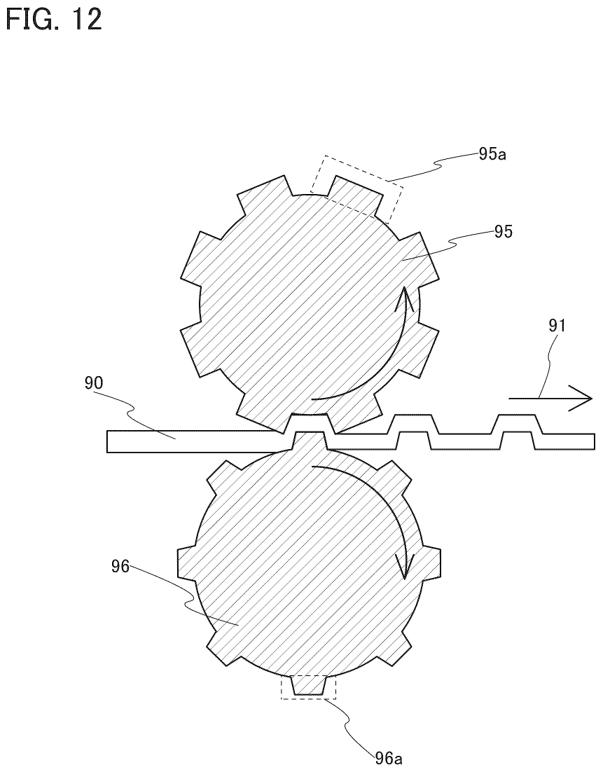

FIG. 12 is a cross-sectional view illustrating an example of embossing. Note that embossing, which is a type of pressing, refers to processing in which an embossing roll whose surface has depressions and projections is brought in contact with a film with pressure to form, on the film, depressions and projections corresponding to the depressions and projections of the embossing roll. Note that the embossing roll is a roll whose surface is engraved with a pattern.

FIG. 12 illustrates an example of embossing both surfaces of a film. FIG. 12 illustrates a method for forming a film having projected portions whose tops are on one surface.

FIG. 12 illustrates a state where a film 90 is sandwiched between an embossing roll 95 in contact with one surface of the film and an embossing roll 96 in contact with the other surface and the film 90 is being transferred in a film travelling direction 91. The surface of the film is patterned by pressure or heat. Note that the surface of the film may be patterned by both pressure and heat.

As the embossing rolls, metal rolls, ceramic rolls, plastic rolls, rubber rolls, organic resin rolls, lumber rolls, or the like can be used as appropriate.

In FIG. 12, embossing is performed using the male embossing roll 96 and the female embossing roll 95. The male embossing roll 96 has a plurality of projections 96a. The projections correspond to projections formed on a film to be processed. The female embossing roll 95 has a plurality of projections 95a. Between the adjacent projections 95a, a depression is positioned into which a projection formed on the film by the projection 96a of the male embossing roll 96 fits.

Successive embossing by which the film 90 partly stands out and debossing by which the film 90 is partly indented can form a projection and a flat portion successively. In this manner, a pattern can be formed on the film 90.

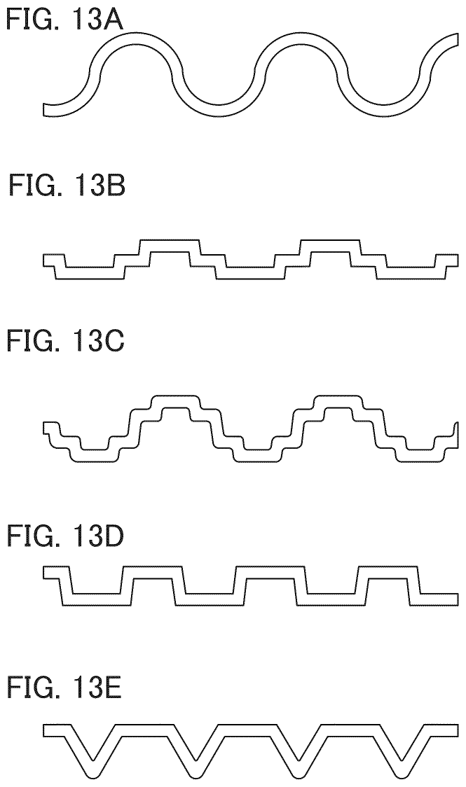

Next, a film having a plurality of projections with a shape different from that in FIG. 12 will be described with reference to FIG. 13A to FIG. 13E. The shape of projections of the embossing roll 95 and the embossing roll 96 in FIG. 12 are changed to a shape different from that in FIG. 12, whereby embossing with various cross-sectional shapes illustrated in FIG. 13A to FIG. 13E can be performed.

FIG. 13A is a schematic cross-sectional view of an embossment having a wave shape, and FIG. 13B to FIG. 13E show variation examples of FIG. 13A. FIG. 13B and FIG. 13C are diagrams illustrating examples of forming a stepwise wave shape, FIG. 13D is a diagram illustrating an example of forming a rectangular wave shape, and FIG. 13E is a diagram illustrating an example of forming a wave shape with acute troughs and trapezoidal crests.

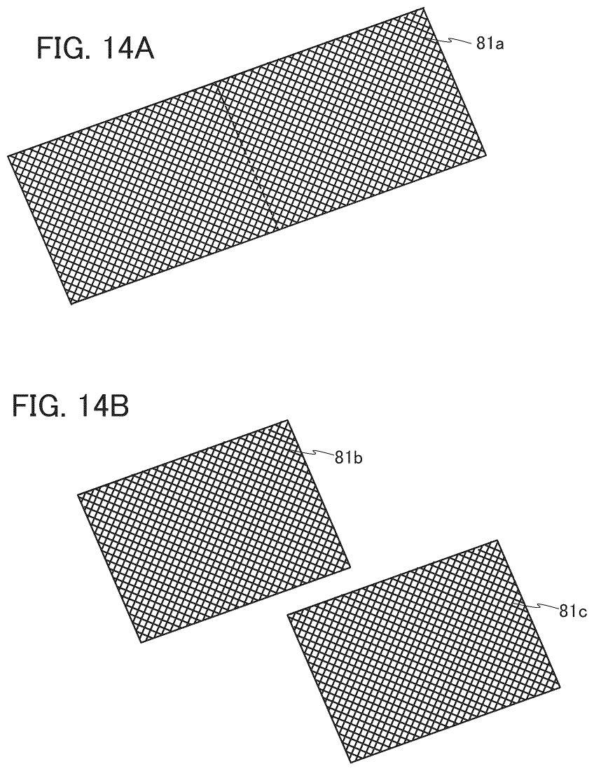

FIG. 14A and FIG. 14B are bird's eye views illustrating the completed shapes obtained by performing the embossing illustrated in FIG. 12 to FIG. 13E twice with different orientations of the film 90. Specifically, embossing is performed on the film 90 in a first direction, and then embossing is performed on the film 90 in a second direction that is rotated 90° with respect to the first direction, whereby a film having an embossed shape (which can be referred to as an alternating wave shape) illustrated in FIG. 14A and FIG. 14B can be obtained. Note that when a battery is fabricated using one film 81a, the film 81a having an alternating wave shape has an external shape illustrated in FIG. 14A and can be used by being folded in two along a dashed line portion. When a battery is fabricated using two films (a film 81b and a film 81c), the plurality of films (the film 81b and the film 81c) each having an alternating wave shape have an external shape illustrated in FIG. 14B, and the film 81b and the film 81c overlap with each other to be used.

Processing using the embossing rolls in the aforementioned manner results in a reduction in apparatus size. Furthermore, a film before being cut can be processed, achieving excellent productivity. Note that a film processing method is not limited to processing using embossing rolls: for example, a film may be processed by pressing a pair of embossing plates having a surface with depressions and projections against the film. In that case, one of the embossing plates may be flat and the film may be processed in a plurality of steps.

In the above-described structure example of the battery, the example is described in which the exterior body on one surface of the battery and the exterior body on the other surface thereof have the same embossed shape; however, the structure of the battery of one embodiment of the present invention is not limited thereto. For example, a battery one surface of which is provided with an exterior body having an embossed shape and the other surface of which is provided with an exterior body not having an embossed shape can be used. Alternatively, the exterior body on one surface of the battery and the exterior body on the other surface thereof may have different embossed shapes.

This embodiment can be implemented in appropriate combination with the other embodiments.

### Embodiment 2

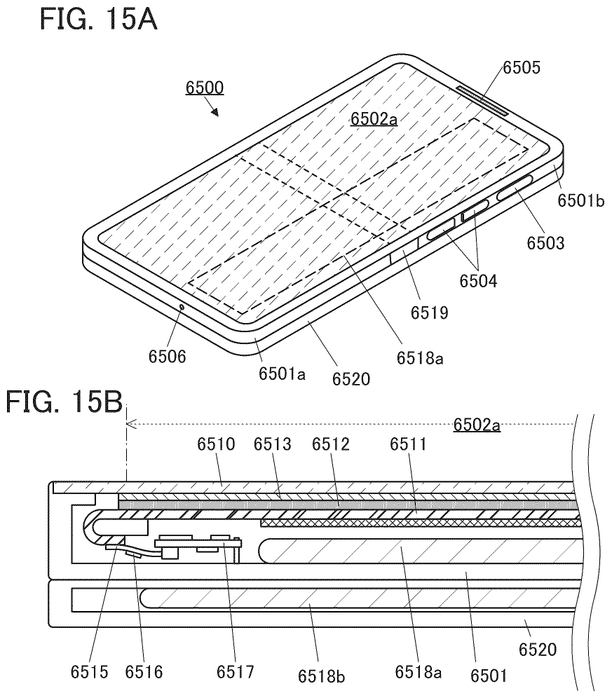

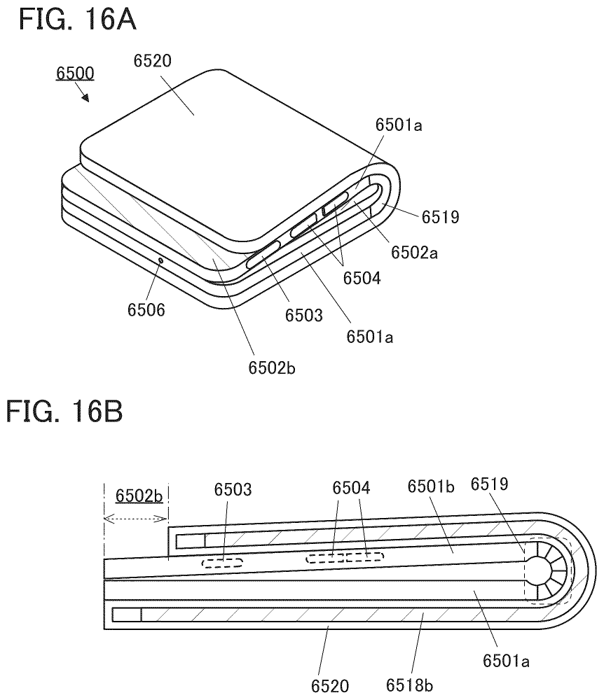

In this embodiment, an electronic device including the battery 10 of one embodiment of the present invention will be described with reference to FIG. 15 and FIG. 16.

An electronic device 6500 illustrated in FIG. 15A is a portable information terminal that can be used as a smartphone.

The electronic device 6500 includes at least a first housing 6501a, a second housing 6501b, a hinge portion 6519, a display portion 6502a, a power button 6503, buttons 6504, a speaker 6505, and a microphone 6506. The display portion 6502a has a touch panel function. The first housing 6501a and the second housing 6501b are connected to each other through the hinge portion 6519.

The electronic device 6500 can be folded at the hinge portion 6519.

FIG. 15B is a schematic cross-sectional view including an end portion of the housing 6501 (6501a and 6501b) on the microphone 6506 side.

A protection member 6510 having a light-transmitting property is provided on a display surface side of the housing 6501 (6501a and 6501b), and a display panel 6511, an optical member 6512, a touch sensor panel 6513, a printed circuit board 6517, and a first battery 6518a are provided in a space surrounded by the housing 6501 (6501a and 6501b) and the protection member 6510.

The display panel 6511, the optical member 6512, and the touch sensor panel 6513 are fixed to the protection member 6510 with an adhesive layer (not illustrated).

Part of the display panel 6511 is folded back in a region outside the display portion 6502a, and an FPC 6515 is connected to the part that is folded back. An IC 6516 is mounted on the FPC 6515. The FPC 6515 is connected to a terminal provided on the printed circuit board 6517.

A flexible display can be used as the display panel 6511. For the flexible display, a plurality of light-emitting elements that are formed using a plurality of flexible films and arranged in a matrix are used. As the light-emitting element, an EL element (also referred to as an EL device) such as an OLED or a QLED is preferably used. Examples of a light-emitting substance contained in the EL element include a substance exhibiting fluorescence (a fluorescent material), a substance exhibiting phosphorescence (a phosphorescent material), an inorganic compound (such as a quantum dot material), and a substance exhibiting thermally activated delayed fluorescence (a thermally activated delayed fluorescence (TADF) material). An LED such as a micro LED can also be used as the light-emitting element.

With the use of the flexible display, the display panel 6511 can be provided at a position overlapping with the first housing 6501a, the second housing 6501b, and the hinge portion 6519, and the display panel 6511 can be folded at the hinge portion 6519.

The use of the flexible display promotes effective utilization of an internal space of the housing 6501 (6501a and 6501b), achieving an ultra-lightweight electronic device. Since the display panel 6511 is extremely thin, the first battery 6518a with high capacity can be mounted while an increase in thickness of the electronic device is suppressed.

Furthermore, in order to use a high-capacity battery, the electronic device 6500 is provided with a second battery 6518b inside a cover portion 6520, and the first battery 6518a and the second battery 6518b are electrically connected to each other although a connection portion therebetween is not illustrated. The flexible battery of one embodiment of the present invention can be applied to the first battery 6518a and the second battery 6518b.

The use of the flexible battery makes it possible to provide the battery at a position overlapping with the first housing 6501a, the second housing 6501b, and the hinge portion 6519 and to fold the battery at the hinge portion 6519.

Moreover, part of the display panel 6511 is folded back so that a connection portion with the FPC 6515 is provided on the back side of a pixel portion, whereby an electronic device with a narrow bezel can be achieved.

When the flexible battery of one embodiment of the present invention is used as one or both of the first battery 6518a and the second battery 6518b, the electronic device 6500 can be partly folded to be downsized, so that the electronic device 6500 with high portability can be achieved.

FIG. 16A is a perspective view illustrating a state where a dotted line portion in FIG. 15A is folded. The electronic device 6500 can be folded in two, and the display portion 6502a and the second battery 6518b can be folded repeatedly.

In FIG. 16A, the display portion 6502b is positioned in a portion exposed when the cover portion 6520 slides by folding. Even when the cover portion 6520 is folded in two, a user can check simple time display or e-mail reception notification display by seeing the second display portion 6502b.

FIG. 16B schematically illustrates a cross-sectional state of the cover portion in a state where the electronic device 6500 is folded. In FIG. 16B, the inside of the housing 6501 (6501a and 6501b) is not illustrated for simplicity.

In FIG. 16B, the hinge portion 6519 can be referred to as a joint portion and can have various modes without limitation to a structure example in which a plurality of columnar bodies are jointed. In particular, the hinge portion 6519 preferably has a mechanism capable of curving the display portion 6502a and the second battery 6518b without expansion and contraction. The second battery 6518b, which is illustrated inside the cover portion 6520, may consist of a plurality of batteries. A charge control circuit or a wireless charge circuit for the second battery 6518b may be provided inside the cover portion 6520.

In this example, the cover portion 6520 is partly fixed to the housing 6501 (6501a and 6501b), and is not fixed to a portion overlapping with the hinge portion 6519 and a portion that is exposed when the cover portion 6520 slides by folding and thus overlaps with the display portion 6502b.

The cover portion 6520 is not necessarily fixed to the housing 6501 (6501a and 6501b) and may be detachable. In the case where high capacity is not necessary, the electronic device 6500 can be used by using the first battery 6518a while the cover portion 6520 is detached. The detached second battery 6518b having being recharged enables auxiliary charge of the first battery 6518a when the second battery 6518b is reconnected to the first battery 6518a. Thus, the cover portion 6520 can also be used as a mobile battery.

Although FIG. 16A and FIG. 16B illustrate an example in which the display portion 6502a is folded in two such that the display surface faces inward, the structure is not particularly limited to this: the hinge portion 6519 may have a structure allowing the display portion 6502a to be folded in two such that the display surface faces outward.

The flexible battery of one embodiment of the present invention has high reliability against repetitive deformation, and thus can be suitably used in such a device that can be folded (also referred to as a foldable device).

At least part of this embodiment can be implemented in combination with the other embodiments described in this specification as appropriate.

### Embodiment 3

In this embodiment, examples of electronic devices each including the battery 10 of one embodiment of the present invention will be described. Examples of the electronic device including the battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

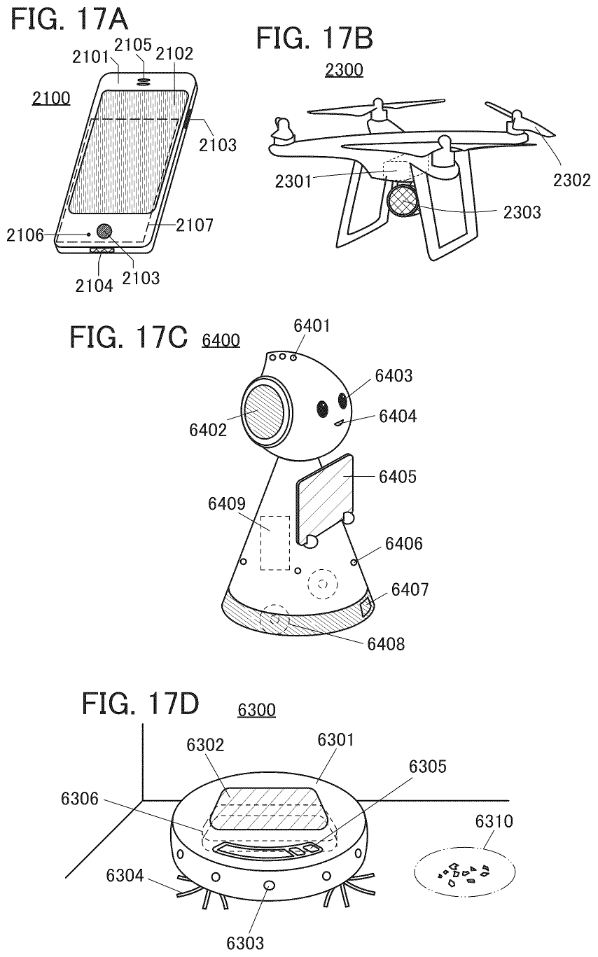

FIG. 17A illustrates an example of a mobile phone. A mobile phone 2100 includes a display portion 2102 set in a housing 2101, operation buttons 2103, an external connection port 2104, a speaker 2105, a microphone 2106, and the like. The mobile phone 2100 includes a battery 2107. The battery 2107 can be bent and thus can be mounted in a bendable region of the mobile phone 2100.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication between the mobile phone 2100 and a headset capable of wireless communication enables hands-free calling.

The mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 17B illustrates an unmanned aircraft 2300 including a plurality of rotors 2302. The unmanned aircraft 2300 is sometimes also referred to as a drone. The unmanned aircraft 2300 includes a battery 2301 of one embodiment of the present invention, a camera 2303, and an antenna (not illustrated). The unmanned aircraft 2300 can be remotely controlled through the antenna. The battery 2301 can be bent and mounted in a bendable region of the unmanned aircraft 2300.

FIG. 17C illustrates an example of a robot. A robot 6400 illustrated in FIG. 17C includes a battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like. The battery 6409 can be bent and mounted in a bendable region of the robot 6400.

The microphone 6402 has a function of detecting a speaking voice of a user, an environmental sound, and the like. The speaker 6404 has a function of outputting sound. The robot 6400 can communicate with the user by using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes, in its inner region, the battery 6409 of one embodiment of the present invention and a semiconductor device or an electronic component.

FIG. 17D illustrates an example of a cleaning robot. A cleaning robot 6300 includes a display portion 6302 placed on a top surface of a housing 6301, a plurality of cameras 6303 placed on a side surface of the housing 6301, a brush 6304, operation buttons 6305, a battery 6306, a variety of sensors, and the like. Although not illustrated, the cleaning robot 6300 is provided with a tire, an inlet, and the like. The cleaning robot 6300 can be self-propelled, detect dust 6310, and suck up the dust through the inlet provided on the bottom surface. The battery 6306 can be bent and mounted in a bendable region of the cleaning robot 6300.

The cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The cleaning robot 6300 includes, in its inner region, the battery 6306 of one embodiment of the present invention and a semiconductor device or an electronic component.

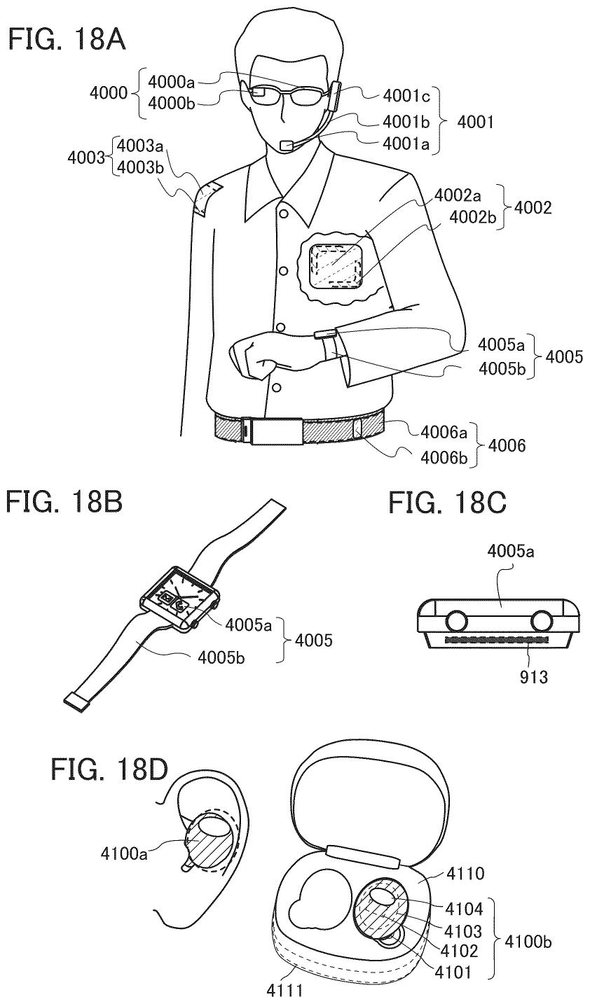

FIG. 18A illustrates examples of wearable devices. A flexible battery is used as a power source of a wearable device. To have improved splash resistance, water resistance, or dust resistance in daily use or outdoor use by a user, a wearable device is desirably capable of being charged wirelessly as well as being charged with a wire whose connector portion for connection is exposed.

For example, the flexible battery of one embodiment of the present invention can be provided in a glasses-type device 4000 illustrated in FIG. 18A. The glasses-type device 4000 includes a frame 4000a and a display portion 4000b. The flexible battery is provided in a temple portion of the frame 4000a having a curved shape, whereby the glasses-type device 4000 can be lightweight, can have a well-balanced weight, and can be used continuously for a long time. The flexible battery can be bent and mounted in a curved portion.

The battery of one embodiment of the present invention can be provided in a headset-type device 4001. The headset-type device 4001 includes at least a microphone portion 4001a, a flexible pipe 4001b, and an earphone portion 4001c. The battery can be provided in the flexible pipe 4001b or the earphone portion 4001c. The battery can be bent and mounted in a curved portion.

The flexible battery of one embodiment of the present invention can be provided in a device 4002 that can be attached directly to a body. A flexible battery 4002b can be provided in a thin housing 4002a of the device 4002. The flexible battery can be bent and mounted in a curved portion.

The flexible battery of one embodiment of the present invention can be provided in a device 4003 that can be attached to clothes. A flexible battery 4003b can be provided in a thin housing 4003a of the device 4003. The flexible battery can be bent and mounted in a curved portion.

The flexible battery of one embodiment of the present invention can be provided in a belt-type device 4006. The belt-type device 4006 includes a belt portion 4006a and a wireless power feeding and receiving portion 4006b, and the flexible battery can be provided in the inner region of the belt portion 4006a. The flexible battery can be bent and mounted in a curved portion.

The flexible battery of one embodiment of the present invention can be provided in a watch-type device 4005. The watch-type device 4005 includes a display portion 4005a and a belt portion 4005b, and the flexible battery can be provided in the display portion 4005a or the belt portion 4005b. The flexible battery can be bent and mounted in a curved portion.

The display portion 4005a can display various kinds of information such as time and reception information of an e-mail or an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 18B illustrates a perspective view of the watch-type device 4005 that is detached from an arm.

FIG. 18C illustrates a side view. FIG. 18C illustrates a state where a flexible battery 913 is incorporated in the inner region. The flexible battery 913 is provided to overlap with the display portion 4005a, can have high density and high capacity, and is small and lightweight. The flexible battery 913 can be bent and mounted in a curved portion.

FIG. 18D illustrates an example of wireless earphones. The wireless earphones illustrated here as an example consist of, but not limited to, a pair of main bodies 4100a and 4100b.

The main bodies 4100a and 4100b each include a driver unit 4101, an antenna 4102, and a flexible battery 4103. A display portion 4104 may also be included. Moreover, a substrate where a circuit such as a wireless IC is provided, a terminal for charge, and the like are preferably included. Furthermore, a microphone may be included. The flexible battery 4103 can be bent and mounted in a curved portion.

A case 4110 includes a flexible battery 4111. Moreover, a substrate where a circuit such as a wireless IC or a charge control IC is provided, and a terminal for charge are preferably included. Furthermore, a display portion, a button, and the like may be included. The flexible battery 4111 can be bent and mounted in a curved portion.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The flexible battery 4103 included in the main body 4100a can be charged by the flexible battery 4111 included in the case 4110. The flexible battery 4111 and the flexible battery 4103 can be bent and mounted in a curved portion.

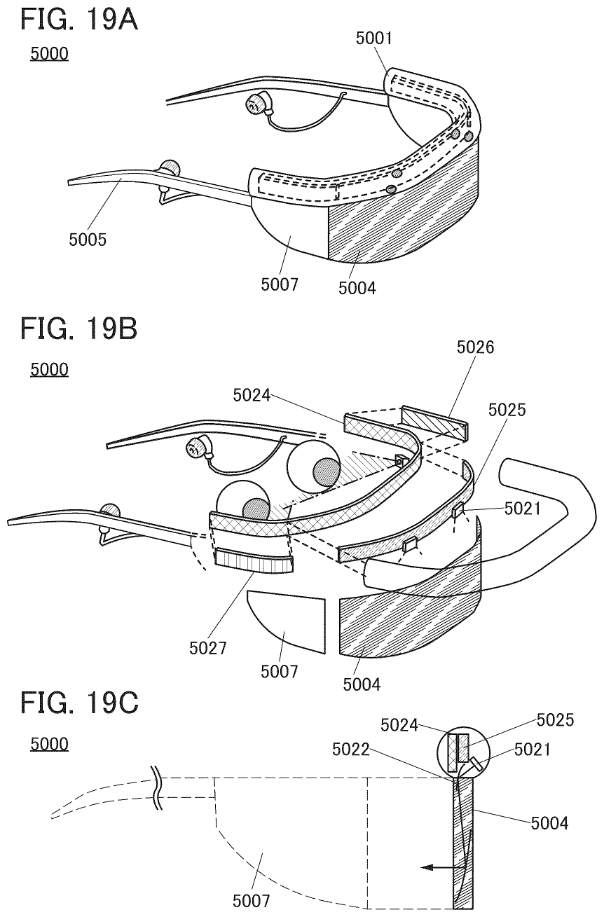

FIG. 19A to FIG. 19C illustrate another example of the glasses-type device. FIG. 19A is a perspective view of a glasses-type device 5000.

The glasses-type device 5000 has a function of what is called a portable information terminal and can execute a variety of programs and reproduce a variety of contents when connected to the Internet, for example. For example, the glasses-type device 5000 has a function of displaying augmented reality contents in an AR mode. The glasses-type device 5000 may have a function of displaying virtual reality contents in a VR mode. Note that the glasses-type device 5000 may also have a function of displaying substitutional reality (SR) contents or mixed reality (MR) contents, in addition to AR and VR contents.

The glasses-type device 5000 includes a housing 5001, an optical component 5004, a wearing tool 5005, a light-blocking portion 5007, and the like. The housing 5001 preferably has a cylindrical shape. The glasses-type device 5000 is preferably wearable on the user's head. Furthermore, it is preferred that the glasses-type device 5000 be worn such that the housing 5001 be positioned above the circumference of the user's head passing through the eyebrows and ears. When the housing 5001 has a cylindrical shape that is curved along the user's head, the glasses-type device 5000 can fit more snugly. The housing 5001 is fixed to the optical component 5004. The optical component 5004 is fixed to the wearing tool 5005 with the light-blocking portion 5007 or the housing 5001 therebetween.

The glasses-type device 5000 includes a display device 5021, a reflective plate 5022, a flexible battery 5024, and a system unit. Each of the display device 5021, the reflective plate 5022, the flexible battery 5024, and the system unit is preferably provided inside the housing 5001. The system unit can be provided with a control unit, a memory unit, and a communication unit included in the glasses-type device 5000, a sensor, and the like. The system unit is preferably provided with a charge circuit, a power supply circuit, and the like. The flexible battery 5024 can be bent and mounted in a curved portion.

FIG. 19B illustrates components included in the glasses-type device 5000 in FIG. 19A. FIG. 19B is a schematic view illustrating details of the components included in the glasses-type device 5000 illustrated in FIG. 19A.

In the glasses-type device 5000 illustrated in FIG. 19B, the flexible battery 5024, a system unit 5026, and a system unit 5027 are provided along the cylindrical housing 5001. A system unit 5025 is provided along the flexible battery 5024 and the like.

The housing 5001 preferably has a curved cylindrical shape. When the flexible battery 5024 is provided along the curved cylinder, the flexible battery 5024 can be provided efficiently in the housing 5001 and the space in the housing 5001 can be used efficiently: as a result, the volume of the flexible battery 5024 can be increased in some cases.

The housing 5001 has a cylindrical shape and the axis of the cylinder is along a part of a substantially elliptical shape, for example. A cross section of the cylinder is preferably substantially elliptical, for example. Alternatively, a part of a cross section of the cylinder preferably has a part of an elliptical shape, for example. In particular, in the case where the glasses-type device 5000 is worn on a head, the part of the cross section having a part of an elliptical shape is preferably positioned on a side facing the head. Note that one embodiment of the present invention is not limited thereto. For example, a part of a cross section of the cylinder may have a polygonal (e.g., triangular, quadrangular, or pentagonal) part.

The housing 5001 is formed so as to be curved along the user's forehead, for example. Alternatively, the housing 5001 is positioned along the user's forehead, for example.

The housing 5001 may be formed using two or more cases in combination. For example, the housing 5001 may be formed using an upper case and a lower case in combination. Alternatively, the housing 5001 may be formed using a case on an inner side (a side in contact with the user) and a case on an outer side in combination, for example. The housing 5001 may be formed using three or more cases in combination.

An electrode can be provided in a portion of the housing 5001 in contact with the user's forehead to measure brain waves using the electrode. Alternatively, an electrode may be provided in a portion in contact with the user's forehead to acquire information such as user's sweat using the electrode.

A plurality of flexible batteries 5024 may be provided inside the housing 5001.

The flexible battery 5024 can be provided along the curved cylinder, which is preferable. The flexible battery has flexibility, and thus can be positioned inside the housing more freely. The flexible battery 5024, a system unit, and the like are provided inside the cylindrical housing. The system unit is provided over a plurality of circuit boards, for example. The plurality of circuit boards and the flexible battery are connected using a connecter, a wiring, and the like. The flexible battery has flexibility, and thus can be positioned so as not to overlap with a connector, a wiring, and the like.

Note that the flexible battery 5024 may be provided, for example, inside the wearing tool 5005 as well as inside the housing 5001.

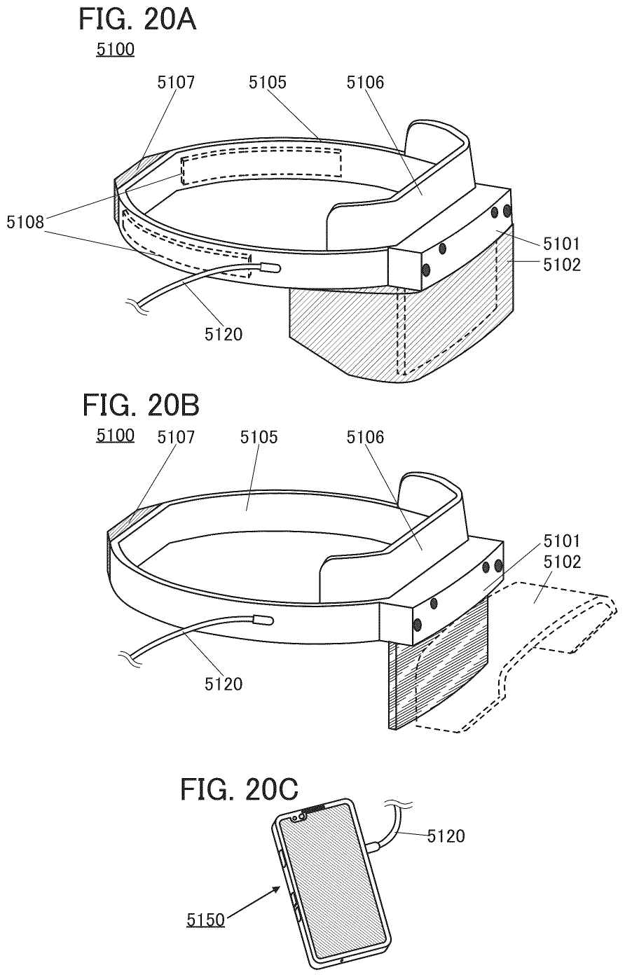

FIG. 20A to FIG. 20C illustrate an example of a head-mounted device. FIG. 20A and FIG. 20B illustrate a head-mounted device 5100 including a wearing tool 5105 with a band-like shape. The head-mounted device 5100 is connected to a terminal 5150 illustrated in FIG. 20C through a cable 5120.

FIG. 20A illustrates the first portion 5102 closing, and FIG. 20B illustrates the first portion 5102 opening. The first portion 5102 has a shape that covers not only the front but also the side of the face when closing. Accordingly, the user's view can be shielded from external light, so that realistic sensation and the sense of immersion can be increased. For example, it is also possible to increase the user's sense of fear in some contents to be displayed.

In the electronic device illustrated in FIG. 20A and FIG. 20B, the wearing tool 5105 has a band-like shape. Accordingly, the electronic device is less likely to slip as compared with the structure illustrated in FIG. 20A and the like and thus is preferable in enjoying contents with relatively large momentum, such as an attraction.

A flexible battery 5107 or the like may be incorporated on the rear head side of the wearing tool 5105. Striking a balance between the weight of the housing 5101 on the front head side and the weight of the flexible battery 5107 on the rear head side can adjust the barycenter of the head-mounted device 5100, whereby the device can be worn more comfortably.

A flexible battery 5108 having flexibility may be provided inside the wearing tool 5105 with a band-like shape. FIG. 20A illustrates an example in which two flexible batteries 5108 are provided inside the wearing tool 5105. The use of the flexible battery having flexibility is preferable, in which case the flexible battery can have a shape following a curved band shape.

The wearing tool 5105 includes a portion 5106 covering the user's forehead or front head. Owing to the portion 5106, the wearing tool 5105 is less likely to slip. An electrode can be provided in the portion 5106 or a portion of the housing 5101 in contact with the user's forehead to measure brain waves using the electrode.

This embodiment can be implemented in appropriate combination with the other embodiments.

### Embodiment 4

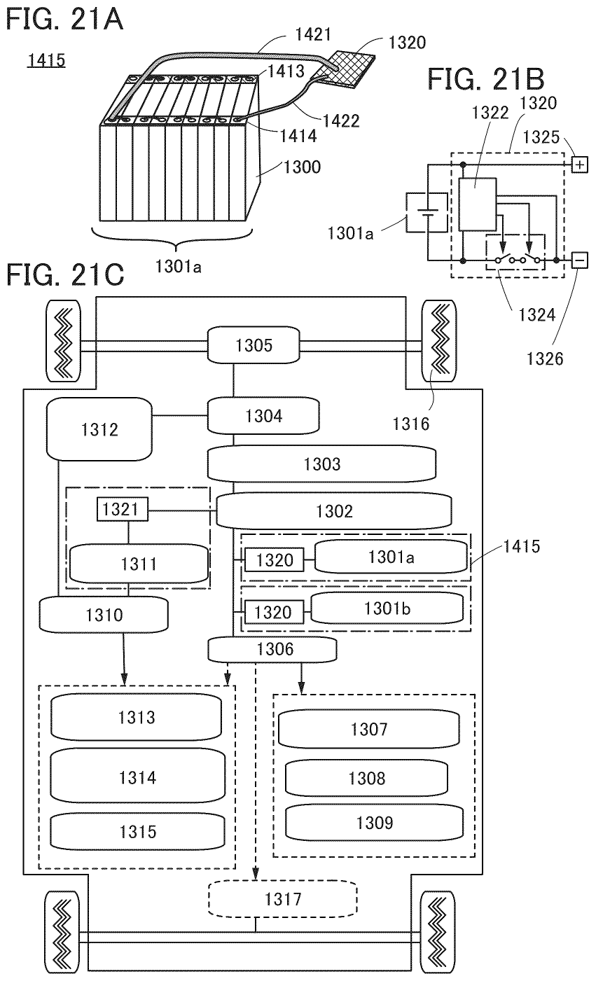

In this embodiment, examples of using the battery of one embodiment of the present invention as a secondary battery for driving an EV and the like will be described with reference to FIG. 21 to FIG. 25.

### [Vehicle]

First, an example in which the secondary battery of one embodiment of the present invention is used in an electric vehicle (EV) will be described.

FIG. 21C shows a block diagram of a vehicle including a motor. The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery or a starter battery. The second battery 1311 needs high output but does not necessarily have high capacity, and the capacity of the second battery 1311 is lower than that of the first batteries 1301a and 1301b.

For example, as one or both of the first batteries 1301a and 1301b, the secondary battery fabricated by the method for manufacturing the secondary battery of one embodiment of the present invention can be used.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is also supplied to in-vehicle parts for 42 V (for a high-voltage system) (such as an electric power steering 1307, a heater 1308, and a defogger 1309) through a DC-DC circuit 1306. Even in the case where there is a rear motor 1317 for rear wheels, the first battery 1301a is used to rotate the rear motor 1317.

The second battery 1311 supplies electric power to in-vehicle parts for 14 V (for a low-voltage system) (such as an audio 1313, power windows 1314, and lamps 1315) through a DC-DC circuit 1310.

The first battery 1301a will be described with reference to FIG. 21A. The internal structure of the first battery 1301a may be the stacked structure illustrated in FIG. 1 and the like or the wound structure illustrated in FIG. 9 and the like.

FIG. 21A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414, a battery container box, or the like. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a BTOS (Battery operating system or Battery oxide semiconductor).

The control circuit portion 1320 senses a terminal voltage of the secondary battery and controls the charge and discharge state of the secondary battery. For example, to prevent overcharge, an output transistor of a charge circuit and an interruption switch can be turned off substantially at the same time.

FIG. 21B illustrates an example of a block diagram of the battery pack 1415 illustrated in FIG. 21A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, or the like. The range from the lower limit voltage to the upper limit voltage of the secondary battery falls within the recommended voltage range: when a voltage falls outside the range, the switch portion 1324 operates and functions as a protection circuit. The control circuit portion 1320 can also be referred to as a protection circuit because it controls the switch portion 1324 to prevent overdischarging or overcharging. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of n-channel transistors and/or p-channel transistors. The switch portion 1324 is not limited to a switch including a Si transistor using single crystal silicon: the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOx (gallium oxide, where x is a real number greater than 0), or the like. A memory element using an OS transistor can be freely placed by being stacked over a circuit using a Si transistor, for example: hence, integration can be easy. Furthermore, an OS transistor can be fabricated with a manufacturing apparatus similar to that for a Si transistor and thus can be fabricated at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). A lead battery is often used for the second battery 1311 due to cost advantage.

This embodiment describes an example in which a lithium-ion secondary battery is used as both the first battery 1301a and the second battery 1311. As the second battery 1311, a lead storage battery, an all-solid-state battery, or an electric double layer capacitor may be used.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charge with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge performance of a secondary battery used, so that fast charge can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used: to prevent overcharge, the first batteries 1301a and 1301b are preferably charged through the control circuit portion 1320. In addition, a connection cable or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

Next, examples in which the secondary battery of one embodiment of the present invention is mounted on a vehicle, typically a transport vehicle, will be described.

By mounting the secondary battery of one embodiment of the present invention on vehicles, next-generation clean energy vehicles such as hybrid vehicles (HVs), electric vehicles (EVs), and plug-in hybrid vehicles (PHVs) can be achieved. The secondary battery can also be mounted on transport vehicles such as agricultural machines like an electric tractor, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. With the use of the method for manufacturing the secondary battery of one embodiment of the present invention, a large secondary battery can be fabricated. Thus, the secondary battery of one embodiment of the present invention can preferably be used in transport vehicles.

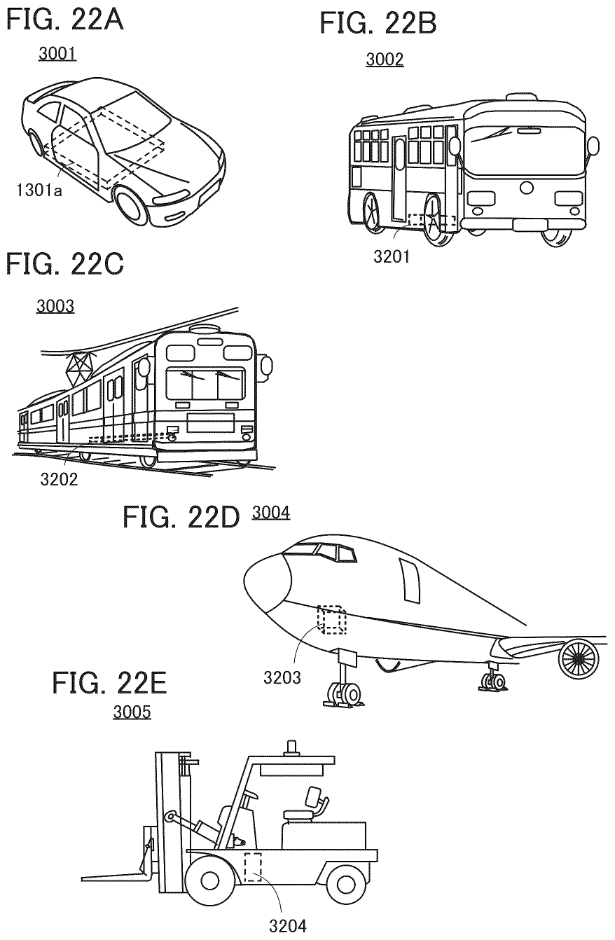

FIG. 22A to FIG. 22E illustrate transport vehicles each using the secondary battery of one embodiment of the present invention. A motor vehicle 3001 illustrated in FIG. 22A is an electric vehicle that runs using an electric motor as a driving power source. Alternatively, the motor vehicle 3001 is a hybrid vehicle that can appropriately select an electric motor or an engine as a driving power source. In the case where the secondary battery is mounted on the vehicle, the secondary battery is provided at one position or several positions. The motor vehicle 3001 illustrated in FIG. 22A includes the battery pack 1415 illustrated in FIG. 21A. The battery pack 1415 includes a secondary battery module. The battery pack 1415 preferably further includes a 20) charge control device that is electrically connected to the secondary battery module. The secondary battery module includes one or more secondary batteries.

The motor vehicle 3001 can be charged when the secondary battery included in the motor vehicle 3001 is supplied with electric power from external charge equipment by a plug-in system, a contactless power feeding system, or the like. In charging, a given method such as CHAdeMO (registered trademark) or Combined Charging System can be employed as a charge method, the standard of a connector, or the like as appropriate. A charge apparatus may be a charge station provided in a commerce facility or a household power supply. For example, with the use of the plug-in system, the secondary battery mounted on the motor vehicle 3001 can be charged by being supplied with electric power from the outside. Charge can be performed by converting AC power into DC power through a converter such as an AC-DC converter.

Although not illustrated, the vehicle may be provided with a power receiving device so that it can be charged by being supplied with electric power from an above-ground power transmitting device in a contactless manner. For the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar panel may be provided in the exterior of the vehicle to charge the secondary battery when the vehicle stops or moves. To supply electric power in such a contactless manner, an electromagnetic induction method or a magnetic resonance method can be used. A solar panel is referred to as a solar cell module in some cases.

FIG. 22B illustrates a large transporter 3002 having a motor controlled by electricity, as an example of a transport vehicle. A secondary battery module of the transporter 3002 has a cell unit of four secondary batteries with 3.5 V or higher and 4.7 V or lower, and 48 cells are connected in series to have a maximum voltage of 170 V. A battery pack 3201 has the same function as the battery pack in FIG. 22A except, for example, the number of secondary batteries configuring the secondary battery module: thus, the description is omitted.

FIG. 22C illustrates a large transport vehicle 3003 having a motor controlled by electricity as an example. A secondary battery module of the transport vehicle 3003 has 100 or more secondary batteries with 3.5 V or higher and 4.7 V or lower which are connected in series, and the maximum voltage is 600 V, for example. Thus, the secondary batteries are required to have a small variation in the characteristics. With the use of the method for manufacturing the secondary battery of one embodiment of the present invention, a secondary battery with stable battery performance can be fabricated, and mass production at low cost is possible in view of the yield. A battery pack 3202 has the same function as the battery pack in FIG. 22A except, for example, the number of secondary batteries configuring the secondary battery module: thus, the description is omitted.

FIG. 22D illustrates an aircraft 3004 having a combustion engine as an example. The aircraft 3004 illustrated in FIG. 22D can be regarded as a kind of transport vehicles since it is provided with wheels for takeoff and landing, and has a battery pack 3203 that includes a charge control device and a secondary battery module configured by connecting a plurality of secondary batteries.

The secondary battery module of the aircraft 3004 has eight 4 V secondary batteries connected in series and has a maximum voltage of 32 V, for example. The battery pack 3203 has the same function as the battery pack in FIG. 22A except, for example, the number of secondary batteries configuring the secondary battery module: thus, the description is omitted.

FIG. 22E illustrates a transport vehicle 3005 that transports a load as an example. The transport vehicle 3005 includes a motor controlled by electricity and executes various operations with the use of electric power supplied from secondary batteries configuring a secondary battery module of a battery pack 3204. The transport vehicle 3005 is not limited to be operated by a human who rides thereon as a driver, and an unmanned operation is also possible by CAN communication or the like. Although FIG. 22E illustrates a forklift, there is no particular limitation and a battery pack including the secondary battery of one embodiment of the present invention can be mounted on industrial machines capable of being operated by CAN communication or the like, e.g., automatic transporters, working robots, and small construction equipment.

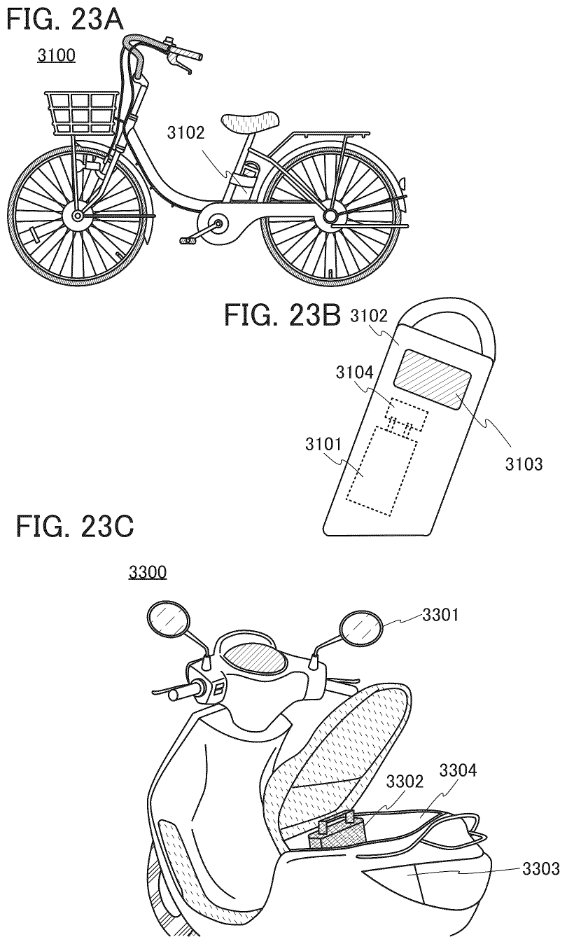

FIG. 23A shows an example of an electric bicycle using the secondary battery of one embodiment of the present invention. The secondary battery of one embodiment of the present invention can be used for an electric bicycle 3100 illustrated in FIG. 23A. A power storage device 3102 illustrated in FIG. 23B includes a plurality of secondary batteries and a protection circuit, for example.

The electric bicycle 3100 includes the power storage device 3102. The power storage device 3102 can supply electricity to a motor that assists a rider. The power storage device 3102 is portable, and FIG. 23B illustrates a state where the power storage device 3102 is detached from the bicycle. A plurality of secondary batteries 3101 of one embodiment of the present invention are incorporated in the power storage device 3102, and the remaining battery capacity and the like can be displayed on a display portion 3103. The power storage device 3102 includes a control circuit 3104 capable of charge control or anomaly detection for the secondary battery, which is exemplified in one embodiment of the present invention. The control circuit 3104 is electrically connected to a positive electrode and a negative electrode of the secondary battery 3101. The control circuit 3104 may be provided with a small solid-state secondary battery. When the small solid-state secondary battery is provided in the control circuit 3104, electric power can be supplied to retain data in a memory circuit included in the control circuit 3104 for a long time. When the control circuit 3104 is used in combination with the secondary battery of one embodiment of the present invention, the synergy on safety can be obtained. The secondary battery of one embodiment of the present invention and the control circuit 3104 can greatly contribute to elimination of accidents due to secondary batteries, such as fires.

FIG. 23C is an example of a motorcycle using the secondary battery of one embodiment of the present invention. A motor scooter 3300 illustrated in FIG. 23C includes a power storage device 3302, side mirrors 3301, and indicator lights 3303. The power storage device 3302 can supply electricity to the indicator lights 3303. The power storage device 3302 including a plurality of secondary batteries of one embodiment of the present invention can have high capacity and contribute to a reduction in size. To improve safety, a protection circuit that prevents overcharging and/or overdischarging of the secondary battery may be electrically connected to the secondary battery.

In the motor scooter 3300 illustrated in FIG. 23C, the power storage device 3302 can be stored in an under-seat storage unit 3304. The power storage device 3302 can be stored in the under-seat storage unit 3304 even with a small size.

### [Building]

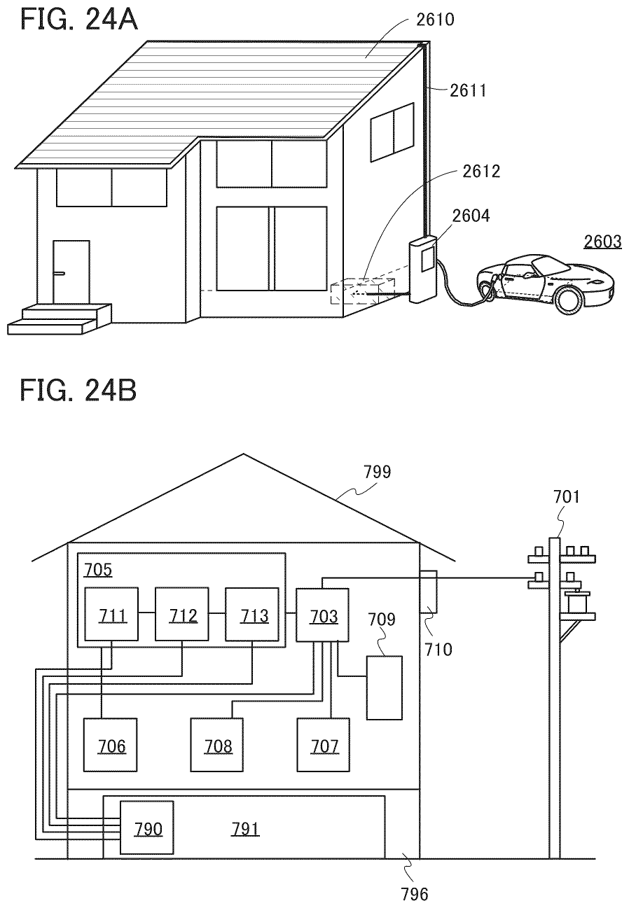

Next, examples in which the secondary battery of one embodiment of the present invention is mounted on a building will be described with reference to FIG. 24.

A house illustrated in FIG. 24A includes a power storage device 2612 including the secondary battery that has stable battery performance by employing the method for manufacturing the secondary battery of one embodiment of the present invention and a solar panel 2610. The power storage device 2612 is electrically connected to the solar panel 2610 through a wiring 2611 or the like. The power storage device 2612 may be electrically connected to ground-based charge equipment 2604. The power storage device 2612 can be charged with electric power generated by the solar panel 2610. A secondary battery included in a vehicle 2603 can be charged with the electric power stored in the power storage device 2612 through the charge equipment 2604. The power storage device 2612 is preferably provided in an underfloor space. When the power storage device 2612 is provided in the underfloor space, the space on the floor can be effectively used. Alternatively, the power storage device 2612 may be provided on the floor.

The electric power stored in the power storage device 2612 can also be supplied to other electronic devices in the house. Thus, with the use of the power storage device 2612 as an uninterruptible power source, electronic devices can be used even when electric power cannot be supplied from a commercial power source due to power failure or the like.

FIG. 24B illustrates an example of a power storage device of one embodiment of the present invention. As illustrated in FIG. 24B, a large power storage device 791 obtained by the method for manufacturing the secondary battery of one embodiment of the present invention is provided in an underfloor space 796 of a building 799.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

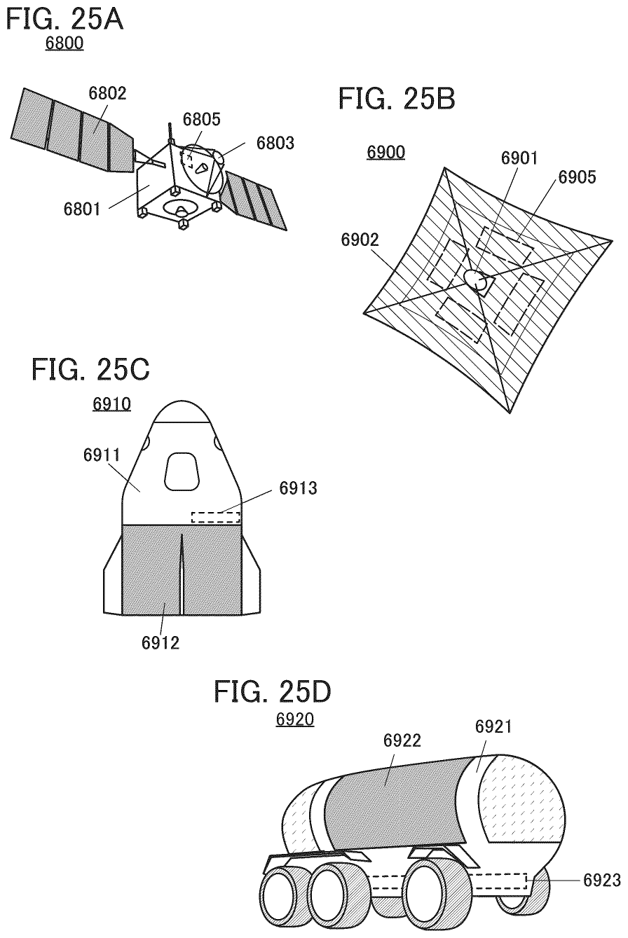

FIG. 25A illustrates an artificial satellite 6800 as an example of a device for space. The artificial satellite 6800 includes a body 6801, a solar panel 6802, an antenna 6803, and a secondary battery 6805. A solar panel is referred to as a solar cell module in some cases.

When the solar panel 6802 is irradiated with sunlight, electric power required for the operation of the artificial satellite 6800 is generated. However, for example, in the situation where the solar panel is not irradiated with sunlight or the amount of sunlight with which the solar panel is irradiated is small, the amount of generated electric power is small. Accordingly, a sufficient amount of electric power required for the operation of the artificial satellite 6800 might not be generated. In order to operate the artificial satellite 6800 even with a small amount of generated electric power, the artificial satellite 6800 is preferably provided with the secondary battery 6805.

The artificial satellite 6800 can generate a signal. The signal is transmitted through the antenna 6803, and can be received by a ground-based receiver or another artificial satellite, for example. When the signal transmitted from the artificial satellite 6800 is received, the position of a receiver that receives the signal can be measured, for example. Thus, the artificial satellite 6800 can construct a satellite positioning system, for example.

Alternatively, the artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of sensing thermal infrared rays emitted from the surface of the earth. Thus, the artificial satellite 6800 can have a function of an earth observing satellite, for example.

FIG. 25B illustrates a probe 6900 including a solar sail as an example of a device for space. The probe 6900 includes a body 6901, a solar sail 6902, and a secondary battery 6905. When photons from the sun are incident on the surface of the solar sail 6902, the momentum is transmitted to the solar sail 6902. Hence, the surface of the solar sail 6902 preferably has a thin film with high reflectance and further preferably faces in the direction of the sun.

The solar sail 6902 folds compact before reaching the outer atmosphere, and is unfurled to have a large thin-film sheet-like shape as illustrated in FIG. 25B in the expanse beyond the earth's atmosphere (outer space). It is thus preferable to use the bendable secondary battery of one embodiment of the present invention as the secondary battery 6905 mounted on the solar sail 6902.

FIG. 25C illustrates a spacecraft 6910 as an example of a device for space. The spacecraft 6910 includes a body 6911, a solar panel 6912, and a secondary battery 6913. The secondary battery of one embodiment of the present invention can be used as the secondary battery 6913. The body 6911 can include a pressurized cabin and an unpressurized cabin, for example. The pressurized cabin may be designed so that the crew can get into the cabin. Electric power that is generated by irradiation of the solar panel 6912 with sunlight can be stored in the secondary battery 6913. Note that the solar panel 6912 and the secondary battery 6913 may each have flexibility. The use of the solar panel 6912 having flexibility is preferable, in which case the solar panel 6912 being in a curved shape can be provided on an outer surface portion of the body 6911. The use of the secondary battery 6913 having flexibility is preferable, in which case the secondary battery 6913 being in a curved shape can be provided on the inner side of the solar panel 6912 (the inner portion side of the body 6911). As the secondary battery 6913 having flexibility, the battery 10E having flexibility, which is described in FIG. 11 and the like, can be used.

FIG. 25D illustrates a rover 6920 as an example of a device for space. The rover 6920 includes a body 6921 and a secondary battery 6923. The rover 6920 may include a solar panel 6922. The secondary battery of one embodiment of the present invention can be used as the secondary battery 6923. The rover 6920 may be designed so that the crew can get into the rover. Electric power that is generated by irradiation of the solar panel 6912 with sunlight may be stored in the secondary battery 6923, or electric power generated by another power source such as a fuel cell or a radioisotope thermoelectric generator, for example, may be stored in the secondary battery 6923. Note that the solar panel 6922 and the secondary battery 6923 may each have flexibility. The use of the solar panel 6922 having flexibility is preferable, in which case the solar panel 6922 being in a curved shape can be provided on an outer surface portion of the body 6921. The use of the secondary battery 6923 having flexibility is preferable, in which case the secondary battery 6923 being in a curved shape can be provided on the inner side of the solar panel 6922 (the inner portion side of the body 6921). As the secondary battery 6923 having flexibility, the battery 10E having flexibility, which is described in FIG. 11 and the like, can be used.

This embodiment can be implemented in appropriate combination with the other embodiments.

### REFERENCE NUMERALS

10: battery, 10B: battery, 20: positive electrode, 21: positive electrode lead, 22: positive electrode current collector, 23: positive electrode active material layer, 24: sealing portion, 25: region, 26: region, 27: region, 28: projecting portion, 29: folded portion, 30: negative electrode, 31: negative electrode lead, 32: negative electrode current collector, 33: negative electrode active material layer, 34: sealing portion, 35: region, 36: region, 37: region, 38: projecting portion, 39: folded portion, 40: separator, 50: exterior body, 51: sealing portion, 52: exterior body, 53: exterior body, 54: exterior body, 60: stack, 60A: stack, 60B: stack, 60C: stack, 60D: stack, 60E: stack, 61: wound body

1. A battery comprising:
an electrode; an exterior body surrounding the electrode; and a lead extending from an inside to an outside of the exterior body,
wherein the electrode comprises a current collector and an active material layer,
wherein the electrode comprises a first region where the active material layer is provided over the current collector, and a second region where the current collector is exposed,
wherein the second region of the electrode comprises a third region where the current collector is folded, and
wherein the lead is connected to the electrode in the third region.

2. The battery according to claim 1,
wherein given that a thickness of the first region is 1, a thickness of the third region is greater than or equal to 0.5 and less than or equal to 2.5.

3. A battery comprising:
an exterior body surrounding a negative electrode, a positive electrode, and a separator;
and a negative lead and a positive lead that extend from an inside to an outside of the exterior body,
wherein the negative electrode comprises a negative electrode current collector and a negative electrode active material layer,
wherein the positive electrode comprises a positive electrode current collector and a positive electrode active material layer,
wherein the separator is positioned between the negative electrode active material layer and the positive electrode active material layer,
wherein the negative electrode comprises a first region where the negative electrode active material layer is provided over the negative electrode current collector, and a second region where the negative electrode current collector is exposed,
wherein the second region of the negative electrode comprises a third region where the negative electrode current collector is folded,
wherein the positive electrode comprises a fourth region where the positive electrode active material layer is provided over the positive electrode current collector, and a fifth region where the positive electrode current collector is exposed,
wherein the fifth region of the positive electrode comprises a sixth region where the positive electrode current collector is folded,
wherein given that a total thickness of a thickness of the first region of the negative electrode, a thickness of the fourth region of the positive electrode, and a thickness of the separator is 1, a thickness of the third region of the negative electrode is greater than or equal to 0.5 and less than or equal to 1.2,
wherein given that the total thickness of the thickness of the first region of the negative electrode, the thickness of the fourth region of the positive electrode, and the thickness of the separator is 1, a thickness of the sixth region of the positive electrode is greater than or equal to 0.5 and less than or equal to 1.2,
wherein the negative electrode lead is connected to the negative electrode in the third region, and
wherein the positive electrode lead is connected to the positive electrode in the sixth region.
